(19) United States
(12) Patent Application Publication
(10) Pub. No.: US 2023/0020633 A1
(43) Pub. Date: Jan. 19, 2023

(54) INFORMATION PROCESSING DEVICE AND METHOD FOR MEDIUM DRAWING IN A VIRTUAL SYSTEM

(71) Applicant: GREE, Inc., Tokyo (JP)

(72) Inventor: Akihiko SHIRAI, Kanagawa (JP)

(73) Assignee: GREE, Inc., Tokyo (JP)

(21) Appl. No.: 17/956,609

(22) Filed: Sep. 29, 2022

Related U.S. Application Data
(63) Continuation of application No. PCT/JP2021/045459, filed on Dec. 10, 2021.

(30) Foreign Application Priority Data
Dec. 14, 2020 (JP) 2020-206435

(51) Int. Cl. G06T 17/00; G06T 13/40; G06Q 30/02

(52) U.S. Cl. CPC G06T 17/00; G06T 13/40; G06Q 30/0255

(57) ABSTRACT

An information processing system that draws a virtual space and that draws multiple mobile media that are moveable in the virtual space and are respectively associated with multiple users. The multiple mobile media include a first mobile medium associated with a user of a first attribute and a second mobile medium associated with a user of a second attribute to whom a predetermined role is assigned in the virtual space, and the image processing system further draws the second mobile medium in a display image for a user of the first attribute or for a user of the second attribute in a manner identifiable from the first mobile medium.

### BACKGROUND

A virtual reality device is known in which a real staff directly or indirectly acts on a user in order to provide the user with realistic bodily sensation in accordance with an experience content of the user by a virtual reality video.

### SUMMARY

In one aspect, an information processing system is provided that includes:
a space drawing processing unit that draws a virtual space; and
a medium drawing processing unit that draws multiple mobile media that can move in the virtual space and are respectively associated with multiple users, wherein
the multiple mobile media include a first mobile medium associated with a user of a first attribute and a second mobile medium associated with a user of a second attribute to whom a predetermined role is assigned in the virtual space, and
the medium drawing processing unit draws the second mobile medium in a display image for a user of the first attribute or for a user of the second attribute in a manner identifiable from the first mobile medium.

According to the present disclosure, various kinds of assistance to a general user by a staff user in a virtual space in virtual reality are enabled.

### BRIEF DESCRIPTION OF THE DRAWINGS

FIG. 1 is a block diagram of a virtual reality generation system according to the present embodiment.

FIG. 2A is an explanatory diagram of an example of virtual reality that can be generated by the virtual reality generation system.

FIG. 2B is an explanatory diagram of another example of virtual reality that can be generated by the virtual reality generation system.

FIG. 2C is an explanatory diagram of yet another example of virtual reality that can be generated by the virtual reality generation system.

FIG. 2D is an explanatory diagram of yet another example of virtual reality that can be generated by the virtual reality generation system.

FIG. 3 is an explanatory diagram of an image of a user avatar located in a virtual space.

FIG. 4 is an example of a functional block diagram of a server device related to a user assistance function.

FIG. 5 is an example of a functional block diagram of a terminal device (terminal device on a transferor side) related to the user assistance function.

FIG. 6 is an explanatory diagram of data in a user database.

FIG. 7 is an explanatory diagram of data in an avatar database.

FIG. 8 is an explanatory diagram of data in a content information storage unit.

FIG. 9 is an explanatory diagram of data in a space state storage unit.

FIG. 10 is a timing chart illustrating an operation example related to the user assistance function.

FIG. 11 illustrates an example of a terminal screen in one scene.

FIG. 12 illustrates an example of a terminal screen in another scene.

FIG. 13 illustrates a state in a content provision virtual space unit at a certain point in time.

FIG. 14 illustrates an example of a terminal screen in yet another scene.

FIG. 15 illustrates an example of a terminal screen in yet another scene.

FIG. 16 illustrates an example of a terminal screen in yet another scene.

FIG. 17 illustrates an example of a terminal screen in yet another scene.

FIG. 18 illustrates an example of a terminal screen in yet another scene.

FIG. 19 is a timing chart illustrating an operation example related to a staff management function.

### DETAILED DESCRIPTION

In the following, an embodiment is described with reference to the drawings.

(Overview of Virtual Reality Generation System)

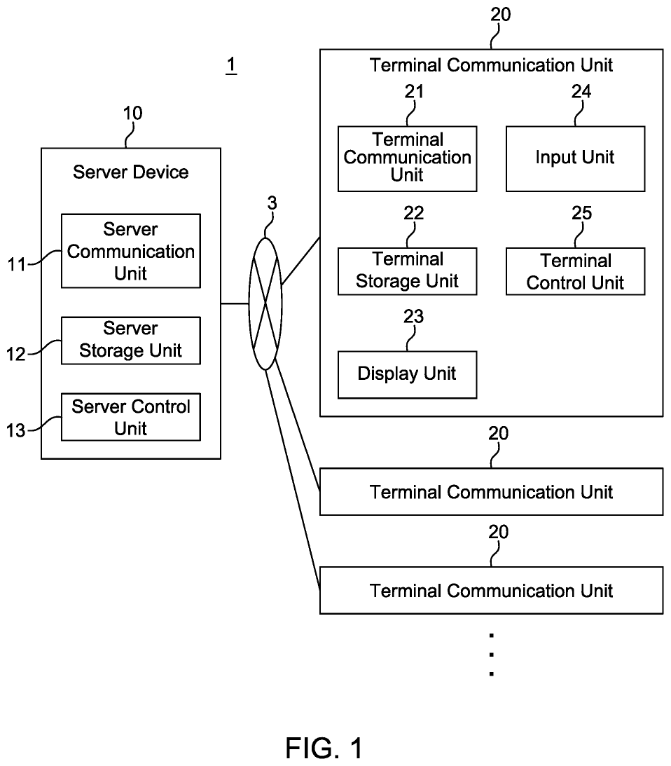

With reference to FIG. 1, an overview of a virtual reality generation system 1 according to an embodiment is described. FIG. 1 is a block diagram of the virtual reality generation system 1 according to the present embodiment. The virtual reality generation system 1 includes a server device 10 and one or more terminal devices 20. For convenience, FIG. 1 illustrates three terminal devices 20. However, the number of terminal devices 20 may be two or more.

The server device 10 is, for example, an information processing system such as a server managed by an operator that provides one or more kinds of virtual reality. The terminal devices 20 are each, for example, an information processing system used by a user, such as a mobile phone, a smartphone, a tablet terminal, a PC (Personal Computer), a head-mounted display, or a game device. Multiple terminal devices 20 can be connected to the server device 10 via a network 3 typically in a manner that can be different from user to user.

The terminal devices 20 can execute virtual reality applications according to the present embodiment. The virtual reality applications may be received by the terminal devices 20 from the server device 10 or a predetermined application distribution server via the network 3, or may be stored in advance in a storage device provided in the terminal devices 20 or a storage medium such as a memory card that can be read by the terminal devices 20. The server device 10 and the terminal devices 20 are communicably connected via the network 3. For example, the server device 10 and the terminal devices 20 cooperatively execute various kinds of processing related to virtual reality.

The network 3 may include a wireless communication network, the Internet, a VPN (Virtual Private Network), a WAN (Wide Area Network), a wired network, or any combination thereof.

Here, an overview of virtual reality according to the present embodiment is described. The virtual reality according to the present embodiment is, for example, virtual reality with respect to any real reality, such as education, travel, role playing, simulation, entertainment, a game, or a concert, and a virtual reality medium such as an avatar is used as virtual reality is executed. For example, the virtual reality according to the present embodiment is realized by a three-dimensional virtual space, various virtual reality media appearing in the virtual space, and various contents provided in the virtual space.

The virtual reality media are electronic data used in virtual reality and includes, for example, any medium such as a card, an item, a point, an in-service currency (or virtual reality currency), a ticket, a character, an avatar, and a parameter. Further, the virtual reality media may be virtual reality related information such as level information, status information, parameter information (a physical strength value, offensive power, and the like), ability information (skills, abilities, spells, jobs, and the like). Further, the virtual reality media are electronic data that can be, for example, acquired, owned, used, managed, exchanged, combined, enhanced, sold, discarded, or gifted by a user in virtual reality. However, the usage of the virtual reality media is not limited to those explicitly described herein.

In the present embodiment, users include a general user (an example of a user of a first attribute) active in a virtual space via a user avatar (m1) (an example of a first mobile medium) to be described later, and a staff user (an example of a user of a second attribute) active in a virtual space via a staff avatar (m2) (an example of a second mobile medium) to be described later. In the following, when the user avatar (m1) and the staff avatar (m2) are not particularly distinguished from each other, they may be simply referred to as “avatars.”

A general user is a user who is not involved in the operation of the virtual reality generation system 1, and a staff user is a user who is involved in the operation of the virtual reality generation system 1. A staff user has a role (agent function) of performing various kinds of assistance for a general user in virtual reality. A staff user may be paid a predetermined salary, for example, based on a contract with the operator. The salary may be in any form, such as currency, cryptographic assets, or the like. In the following, unless otherwise specified, “a user” refers to both a general user and a staff user.

Further, the users may further include a guest user. A guest user may be an artist, an influencer, or the like that operates a guest avatar that functions as a content (content provided by the server device 10) to be described later. Some of staff users may be guest users.

In the present embodiment, a staff user can basically be a general user. In other words, general users include general users who can be staff users, and general users who cannot be staff users. Staff users may include a user who can only be a staff user.

Types and number of contents (contents provided in virtual reality) provided by the server device 10 are arbitrary. However, in the present embodiment, for example, the contents provided by the server device 10 may include digital contents such as various videos. A video may be a real-time video or a non-real-time video. Further, a video may be a video based on a real image, or may be a video based on CG (Computer Graphics). A video may be a video for providing information. In this case, a video may be related to an information providing service of a specific genre (an information providing service related to travel, residence, food, fashion, health, beauty, and the like), a broadcasting service by a specific user (for example, YouTube (registered trademark)), and the like.

Further, in the present embodiment, as an example, contents provided by the server device 10 may include guidance, advice, and the like from a staff user to be described later. For example, contents provided in virtual reality related to a dance lesson may include guidance and advice from a dance teacher. In this case, the dance teacher becomes a staff user, a student becomes a general user, and the student can receive individual guidance from the teacher in virtual reality.

Further, in other embodiments, the contents provided by the server device 10 may be various performances, talk shows, meetings, gatherings, and the like via respective staff avatars (m2) or guest avatars by one or more staff users or guest users.

A mode of providing contents in virtual reality is arbitrary. For example, when a content is a video, the content may be provided by drawing the video on a display of a display device (virtual reality medium) in a virtual space. The display device in a virtual space may be of any form, such as a screen arranged in a virtual space, a large screen display arranged in a virtual space, a display of a portable terminal in a virtual space, or the like.

(Structure of Server Device)

A structure of the server device 10 is specifically described. The server device 10 is formed of a server computer. The server device 10 may be cooperatively realized by multiple server computers. For example, the server device 10 may be cooperatively realized by a server computer that provides various contents, a server computer that realizes various authentication servers, and the like. Further, the server device 10 may include a Web server. In this case, some of the functions of the terminal devices 20 to be described later may be realized by a browser processing HTML documents received from the Web server and various programs (Javascript) associated with the HTML documents.

The server device 10 includes a server communication unit 11, a server storage unit 12, and a server control unit 13.

The server communication unit 11 includes an interface that communicates with an external device wirelessly or wiredly and transmits and receives information. The server communication unit 11 may include, for example, a wireless LAN (Local Area Network) communication module or a wired LAN communication module, or the like. The server communication unit 11 can transmit and receive information to and from the terminal devices 20 via the network 3.

The server storage unit 12 is, for example, a storage device and stores various kinds of information and programs necessary for various kinds of processing related to virtual reality. For example, the server storage unit 12 stores virtual reality applications.

Further, the server storage unit 12 stores data for drawing a virtual space, for example, an image or the like of an indoor space such as a building, or an outdoor space. Multiple kinds of data for drawing a virtual space may be prepared and properly used for each virtual space.

Further, the server storage unit 12 stores various images (texture images) for projecting (texture mapping) onto various objects arranged in a three-dimensional virtual space.

For example, the server storage unit 12 stores drawing information of a user avatar (m1) as a virtual reality medium associated with a user. In a virtual space, a user avatar (m1) is drawn based on the drawing information of the user avatar (m1).

Further, the server storage unit 12 stores drawing information of a staff avatar (m2) as a virtual reality medium associated with a staff user. In a virtual space, a staff avatar (m2) is drawn based on the drawing information of the staff avatar (m2).

Further, the server storage unit 12 stores drawing information related to various objects different from a user avatar (m1) or a staff avatar (m2), such as a building, a wall, a tree, or an NPC (Non Player Character). Various objects in a virtual space are drawn based on such drawing information.

In the following, an object corresponding to any virtual reality medium (for example, a building, a wall, a tree, an NPC, or the like) different from a user avatar (m1) or a staff avatar (m2) is also referred to as a second object (m3). In the present embodiment, second objects may include an object fixed in a virtual space, an object movable in a virtual space, or the like. Further, second objects may include an object that is always arranged in a virtual space, an object that is arranged in a virtual space only when a predetermined condition is satisfied, and the like.

The server control unit 13 may include a dedicated microprocessor or a CPU (Central Processing Unit) that realizes a specific function by reading in a specific program, a GPU (Graphics Processing Unit), or the like. For example, in cooperation with a terminal device 20, the server control unit 13 executes a virtual reality application in response to a user operation with respect to a display unit 23 of the terminal device 20. Further, the server control unit 13 executes various kinds of processing relating to virtual reality.

For example, the server control unit 13 draws a user avatar (m1), a staff avatar (m2), or the like together with a virtual space (image), and displays the same on the display unit 23. Further, the server control unit 13 moves a user avatar (m1) or a staff avatar (m2) in a virtual space according to a predetermined user operation. Details of specific processing of the server control unit 13 will be described later.

(Structure of Terminal Device)

A structure of a terminal device 20 is described. As illustrated in FIG. 1, a terminal device 20 includes a terminal communication unit 21, a terminal storage unit 22, the display unit 23, an input unit 24, and a terminal control unit 25.

The terminal communication unit 21 includes an interface that communicates with an external device wirelessly or wiredly and transmits and receives information. For example, the terminal communication unit 21 may include a wireless communication module, a wireless LAN communication module, a wired LAN communication module, or the like corresponding to mobile communication standards such as LTE (Long Term Evolution) (registered trademark), LTE-A (LTE-Advanced), 5G mobile communication system, and UMB (Ultra Mobile Broadband). The terminal communication unit 21 can transmit and receive information to and from the server device 10 via the network 3.

The terminal storage unit 22 includes, for example, a primary storage device and a 2 storage device. For example, the terminal storage unit 22 may include a semiconductor memory, a magnetic memory, an optical memory, or the like. The terminal storage unit 22 stores various kinds of information and programs that are received from the server device 10 and used in processing of virtual reality. The information and programs used in processing of virtual reality may be acquired from an external device via the terminal communication unit 21. For example, a virtual reality application program may be acquired from a predetermined application distribution server. In the following, an application program is also simply referred to as an application. Further, for example, a part or all of the above-described information about the user and information about the virtual reality media of other users may be acquired from the server device 10.

The display unit 23 includes, for example, a display device such as a liquid crystal display or an organic EL (Electro Luminescence) display. The display unit 23 can display various images. The display unit 23 is formed of, for example, a touch panel, and functions as an interface that detects various user operations. The display unit 23 may be in the form of a head-mounted display.

The input unit 24 includes, for example, an input interface including a touch panel integrally provided with the display unit 23. The input unit 24 is capable of accepting a user input with respect to the terminal device 20. Further, the input unit 24 may include a physical key, or may further include any input interfaces including a pointing device such as a mouse. Further, the input unit 24 may be capable of accepting a non-contact type user input such as a voice input or a gesture input. For a gesture input, sensors (an image sensor, an acceleration sensor, a distance sensor, and the like) for detecting a movement of a user's body, a dedicated motion capture that integrates a sensor technology and a camera, a controller such as a joystick, or the like may be used.

The terminal control unit 25 includes one or more processors. The terminal control unit 25 controls the operation of the entire terminal device 20.

The terminal control unit 25 transmits and receives information via the terminal communication unit 21. For example, the terminal control unit 25 receives various kinds of information and programs used in various kinds of processing related to virtual reality from at least one of the server device 10 and other external servers. The terminal control unit 25 stores the received information and programs in the terminal storage unit 22. For example, a browser (Internet browser) for connecting to a Web server may be stored in the terminal storage unit 22.

The terminal control unit 25 starts a virtual reality application in response to a user operation. In cooperation with the server device 10, the terminal control unit 25 executes various kinds of processing related to virtual reality. For example, the terminal control unit 25 causes the display unit 23 to display an image of a virtual space. For example, a GUI (Graphic User Interface) that detects a user operation may be displayed on a screen. The terminal control unit 25 can detect a user operation with respect to the screen via the input unit 24. For example, the terminal control unit 25 can detect a tap operation, a long tap operation, a flick operation, a swipe operation, and the like of a user. A tap operation is an operation in which a user touches the display unit 23 with a finger and then releases the finger. The terminal control unit 25 transmits the operation information to the server device 10.

(Example of Virtual Reality)

In cooperation with the terminal devices 20, the server control unit 13 displays an image of a virtual space on the display unit 23, and updates the image of the virtual space in accordance with progress of the virtual reality or an operation of a user. In the present embodiment, in cooperation with the terminal devices 20, the server control unit 13 draws an object arranged in a three-dimensional virtual space in an expression viewed from a virtual camera arranged in the virtual space.

Drawing processing described below is realized by the server control unit 13. However, in other embodiments, a part or all of the drawing processing described below may be realized by the server control unit 13. For example, in the following description, at least a part of an image of a virtual space displayed on a terminal device 20 is a web display displayed on the terminal device 20 based on data generated by the server device 10, and at least a part of a screen may be a native display displayed by a native application installed on the terminal device 20.

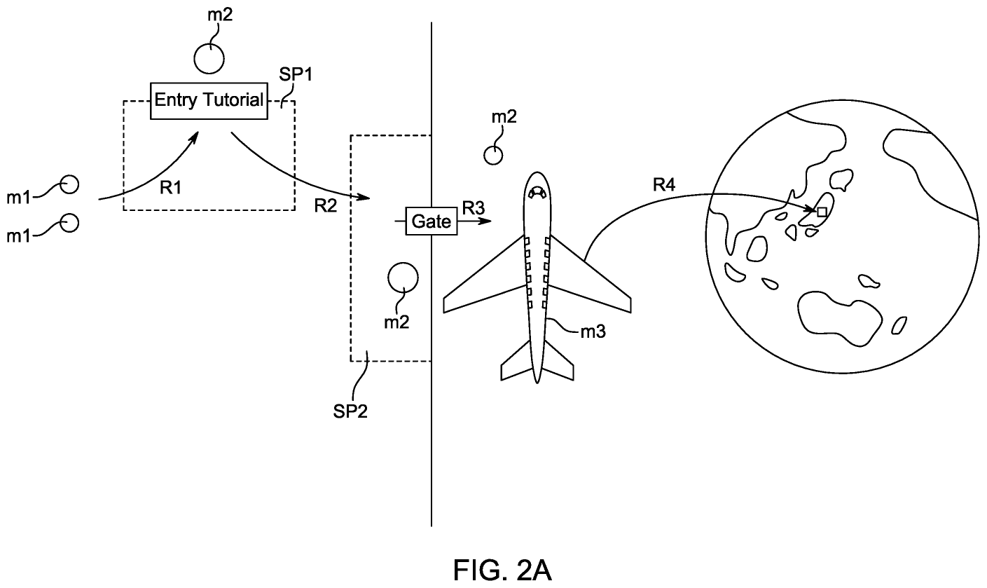

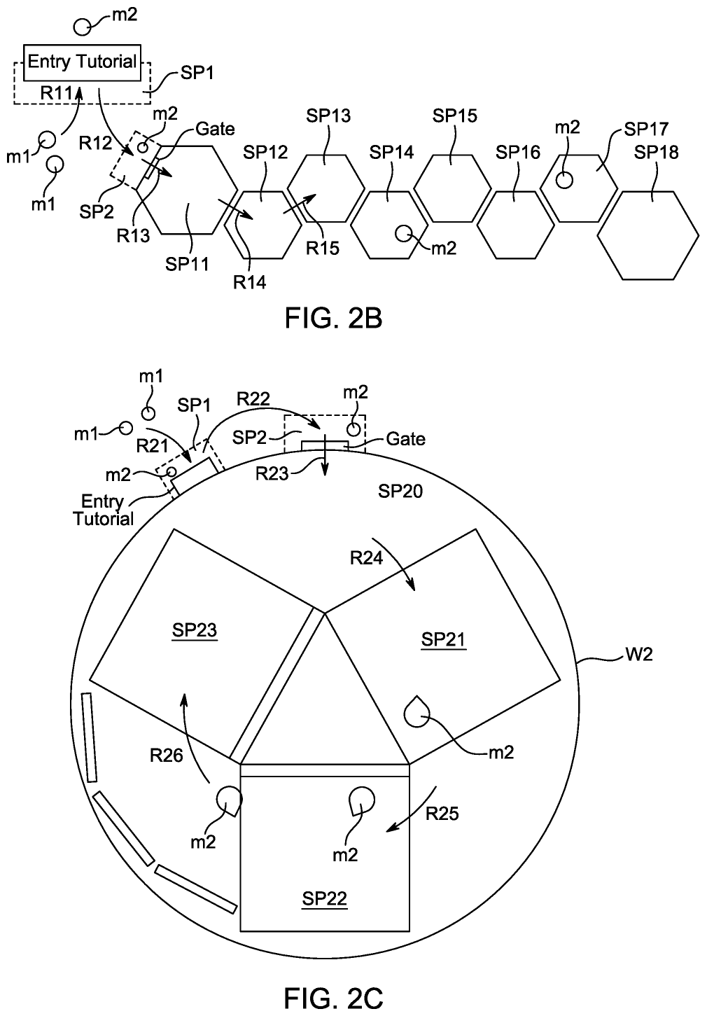

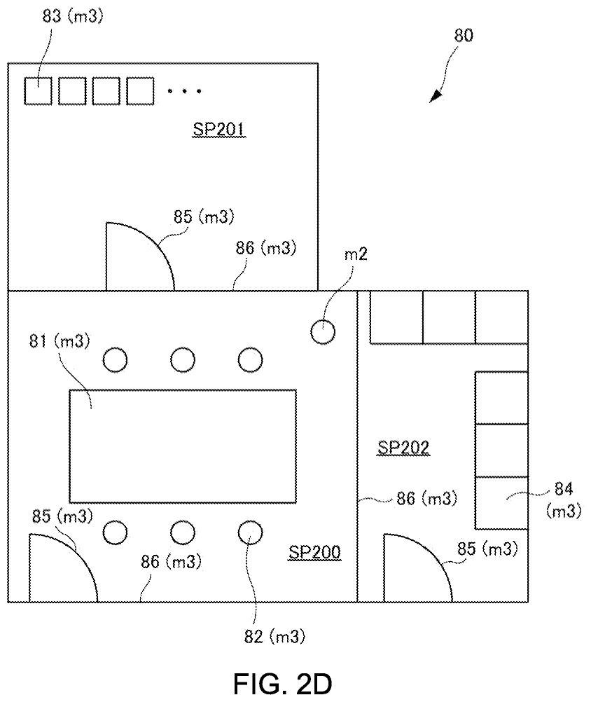

FIGS. 2A-2D are explanatory diagrams of some examples of virtual reality that can be generated by the virtual reality generation system 1.

FIG. 2A is an explanatory diagram of virtual reality related to travel, and is a conceptual diagram illustrating a virtual space in a plan view. In this case, a location (SP1) for viewing a content of an entry tutorial and a location (SP2) near a gate are set in the virtual space. In FIG. 2A, user avatars (m1) associated with two different users are illustrated. Further, in FIG. 2A (the same also applies to FIG. 2B and so on), staff avatars (m2) are also illustrated.

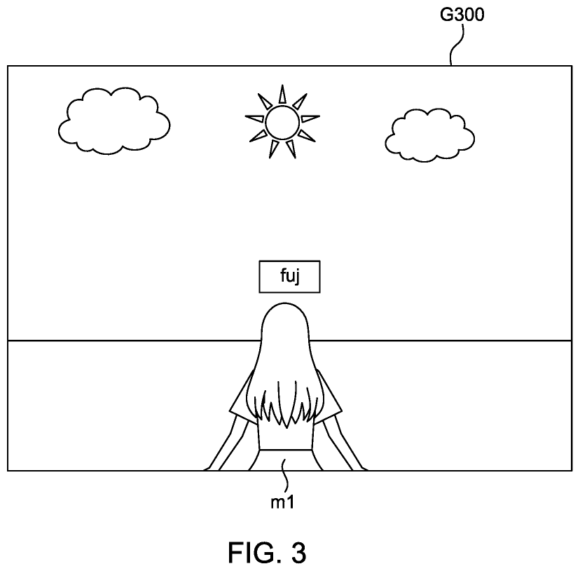

The two users decide to travel together in virtual reality and enter the virtual space via their respective user avatars (m1). Then, the two users view the content of the entry tutorial at the location (SP1) via their respective user avatars (m1) (see an arrow (R1)), reach the location (SP2) (see an arrow (R2)), then pass through the gate (see an arrow (R3)), and board an airplane (a second object (m3)). The content of the entry tutorial may include an entry method, precautions when using the virtual space, or the like. Then, the airplane takes off and reaches a desired destination (see an arrow (R4)). During this time, the two users can experience the virtual reality via the display units 23 of their respective terminal devices 20. For example, FIG. 3 illustrates an image (G300) of a user avatar (m1) located in a virtual space related to a desired destination. Such an image (G300) may be displayed on the terminal device 20 of the user associated with this user avatar (m1). In this case, the user can move in the virtual space via the user avatar (m1) (to which a user name “fuj” is assigned), and can perform sightseeing and the like.

FIG. 2B is an explanatory diagram of virtual reality related to education, and is a conceptual diagram illustrating a virtual space in a plan view. Also in this case, a location (SP1) for viewing a content of an entry tutorial and a location (SP2) near a gate are set in the virtual space. In FIG. 2B, user avatars (m1) associated with two different users are illustrated.

The two users decide to receive specific education together in virtual reality and enter the virtual space via their respective user avatars (m1). Then, the two users view the content of the entry tutorial at the location (SP1) via their respective user avatars (m1) (see an arrow (R11)), reach the location (SP2) (see an arrow (R12)), then pass through the gate (see an arrow (R13)), and reach a first location (SP11). At the first location (SP11), a specific first content is provided. Next, via their respective user avatars (m1), the two users reach a second location (SP12) (see an arrow (R14)), receive provision of a specific second content, then reach a third location (SP13) (see an arrow (R15)), receive provision of a specific third content, and so on. A learning effect is higher when the specific second content is provided after the provision of the specific first content is received, and a learning effect is higher when the specific third content is provided after the provision of the specific second content is received, and so on.

For example, when the education is about software for certain 3D modeling, the first content may include an installation link image or the like of the software, the second content may include an installation link video or the like of an add-on, the third content may include a video for initial setting, the fourth content may include a video for basic operation, and so on. Further, when multiple users are in the same room, the same video content may be played at the same timing (a playback time code is transmitted to both client sides). Further, it is also possible for each user to have a different video seek state without synchronous playback. Each user can use a camera connected to the terminal to transmit a face image in real time. Further, it is possible to display a desktop of a user's computer or to deliver screens of other applications to each other (to get help by arranging application learning side by side).

In the example illustrated in FIG. 2B, by moving via a user avatar (m1) sequentially from the first location (SP11) to an eighth location (SP18) and receiving sequentially the provision of various contents, each user (for example, a student) can receive a specific education in a manner that a high learning effect is achieved. Or, various contents may be challenges such as quizzes, and in this case, in the example illustrated in FIG. 2B, games such as Sugoroku, and Escape can be provided.

FIG. 2C is an explanatory diagram of virtual reality related to a lesson, and is a conceptual diagram illustrating a virtual space in a plan view. Also in this case, a location (SP1) for viewing a content of an entry tutorial and a location (SP2) near a gate are set in the virtual space. In FIG. 2C, user avatars (m1) associated with two different users are illustrated.

The two users decide to receive a specific lesson together in virtual reality and enter the virtual space via their respective user avatars (m1). Then, the two users view the content of the entry tutorial at the location (SP1) via their respective user avatars (m1) (see an arrow (R21)), reach the location (SP2) (see an arrow (R22)), then pass through the gate (see an arrow (R23)), and reach a location (SP20). For example, the location (SP20) corresponds to locations in free spaces excluding locations (SP21,SP22, SP23) corresponding to stages or the like in a region surrounded by a circular peripheral wall (W2). When the users reach the first location (SP21) corresponding to a first stage via their respective user avatars (m1) (see an arrow (R24)), the users receive, at the first location (SP21), provision of a first content for a lesson. Further, similarly, when the users reach the second location (SP22) corresponding to a second stage via their respective user avatars (m1) (see an arrow (R25)), the users can receive, at the second location (SP22), provision of a second content for a lesson; and when the users reach the third location (SP23) corresponding to a third stage (see an arrow (R26)), the users can receive, at the third location (SP23), provision of a third content for a lesson.

For example, when the lessons are golf lessons, the first content for a lesson may be a video for explaining improving points of the user's swing; the second content for a lesson is a demonstration of a practical swing by a staff user who is a professional golfer; and the third content for a lesson is advice by a staff user who is a professional golfer with respect to the user's practical swing. The demonstration of a practical swing by a staff user is realized by a staff avatar (m2), and the user's practical swing is realized by a user avatar (m1). For example, when a staff user actually performs a swing movement, based on data of the movement (for example, gesture input data), the movement is directly reflected in a movement of the staff avatar (m2). The advice by a staff user may be realized by chat or the like. In this way, each user can take a variety of lessons together with a friend in virtual reality, for example, at home from a teacher (in this case a professional golfer) at a sufficient and necessary pace and depth.

In this way, in the present embodiment, as illustrated in FIGS. 2A-2C, in virtual reality, when a user reaches each content provision location via a user avatar (m1), the user can receive the each content provision corresponding to the each content provision location at a timing and a viewing mode required by the user.

FIG. 2D is an explanatory diagram of virtual reality related to a staff user, and is a conceptual diagram illustrating a virtual space 80 related to a staff room in a plan view. In the example illustrated in FIG. 2D, the virtual space 80 for a staff user includes a location (SP200) that forms a space unit corresponding to a conference room, a location (SP201) that forms a space unit corresponding to a backyard, and a location (SP202) that forms a space unit corresponding to a locker room. The space units are partitioned by second objects (m3) corresponding to walls 86, and it may be possible to enter or leave a room by opening or closing a second object (m3) corresponding to a door 85.

A table 81 (a second object (m3)) and chairs 82 (second objects (m3)) are arranged in the space unit corresponding to the conference room, commodities 83 (m3) are stored in the space unit corresponding to the backyard, and lockers 84 (second objects (m3)) are arranged in the space unit corresponding to the locker room. In the locker 84, uniforms (second objects (m3)) (to be described later) may be stored, and a user who can become a staff user can change to a staff user by having the avatar of the user wear a uniform in the locker room. The layout and the like of the virtual space 80 for a staff user can be various and may be appropriately set in accordance with the number of staff users and the like.

Such a virtual space 80 for a staff user may be arranged adjacent to the virtual spaces illustrated in FIGS. 2A-2C. In this case, for example, a staff user who performs various kinds of assistance in the virtual space illustrated in FIG. 2A can use the virtual space 80 arranged adjacent to the virtual space illustrated in FIG. 2A.

However, when things that can be realized in a virtual space are diverse, or when a structure (such as a layout of locations where provisions of multiple contents are respectively received) in a virtual space becomes complicated, while attractiveness of the virtual space can be enhanced, rules are likely to become more complicated. In this case, it is likely that a user may have a hard time getting used to such rules, or when something goes wrong, it is likely that the user cannot solve the problem and becomes disgusted.

In this regard, it can be expected that, by pasting tutorials about the rules and the like in a virtual space, it may be possible for users to carry out smooth activities in the virtual space to some extent. However, when the number of tutorials increases with diversification of things that can be realized in a virtual space, there is a risk of impairing convenience.

On the other hand, in the present embodiment, the virtual reality generation system 1 has an assistance function (hereinafter, also referred to as a “user assistance function”) for providing various kinds of assistance via a staff avatar (m2). As a result, even in a relatively complex virtual space, it is possible to assist smooth activities of the users in a highly convenient manner. Such a user assistance function is even more useful when there is a mechanism for generating prices with respect to various activities of staff avatars (m2) (staff users) in a virtual space in virtual reality.

Therefore, in the present embodiment, as will be described in detail later, the virtual reality generation system 1 further has a function (hereinafter, also referred to as “staff management function”) for appropriately evaluating various activities related to the user assistance function among various activities of staff avatars (m2) (staff users) in a virtual space in virtual reality. By having such a staff management function, it is possible to appropriately generate prices for various activities of staff avatars (m2) (staff users) in a virtual space in virtual reality.

In the following, the server device 10 realizes an example of an information processing system by realizing the user assistance function and the staff management function. However, as will be described later, each element of a specific terminal device 20 (see the terminal communication unit 21-the terminal control unit 25 in FIG. 1) may realize an example of an information processing system, or multiple terminal devices 20 may cooperatively realize an example of an information processing system. Further, the server device 10 and one or more terminal devices 20 may cooperatively realize an example of an information processing system.

(Details of the User Assistance Function and the Staff Management Function)

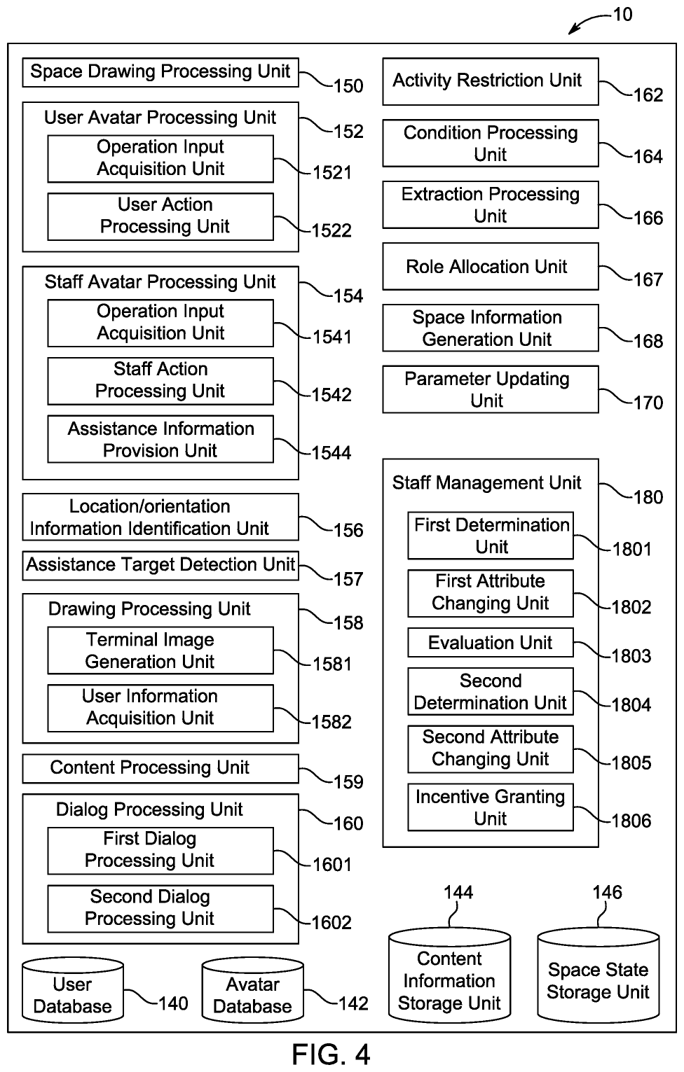

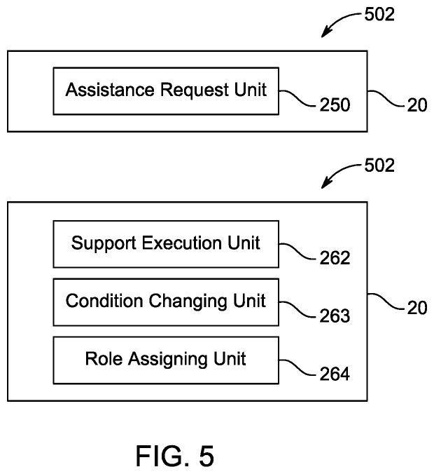

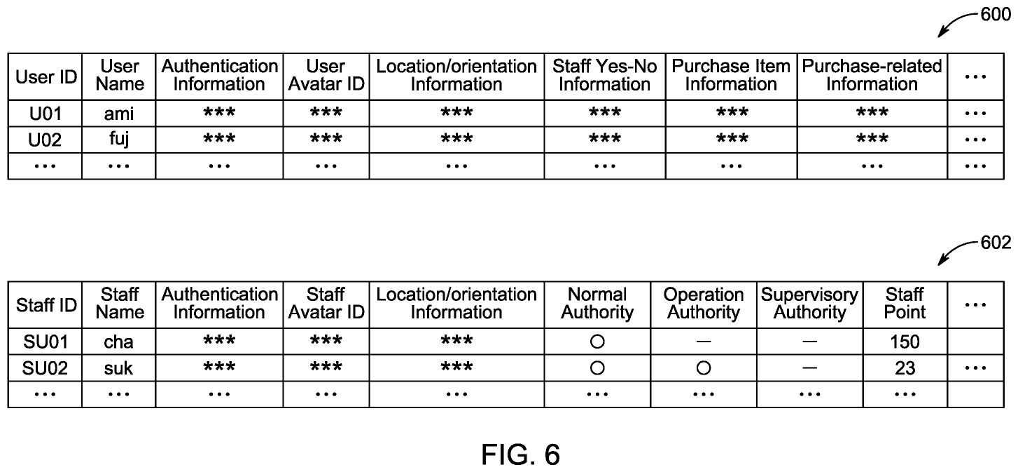

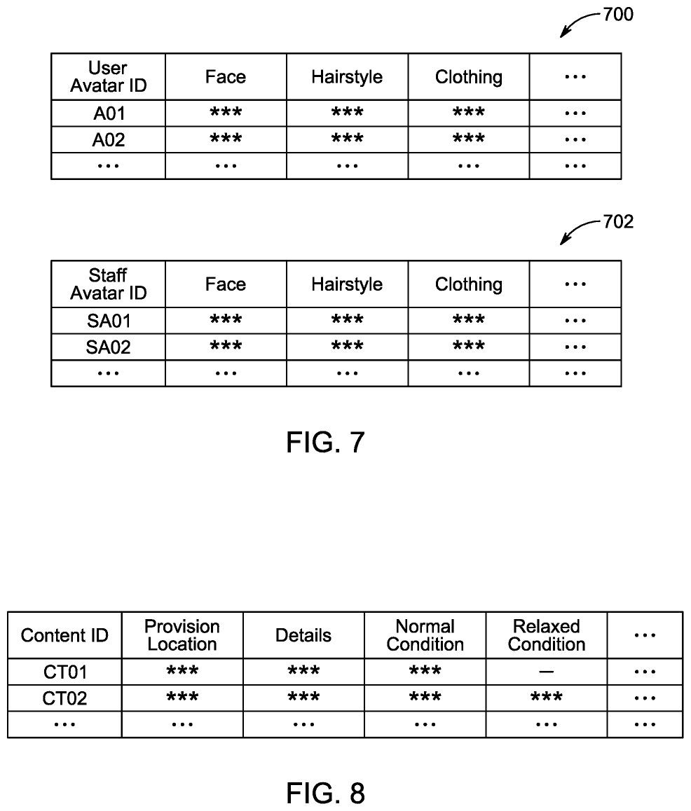

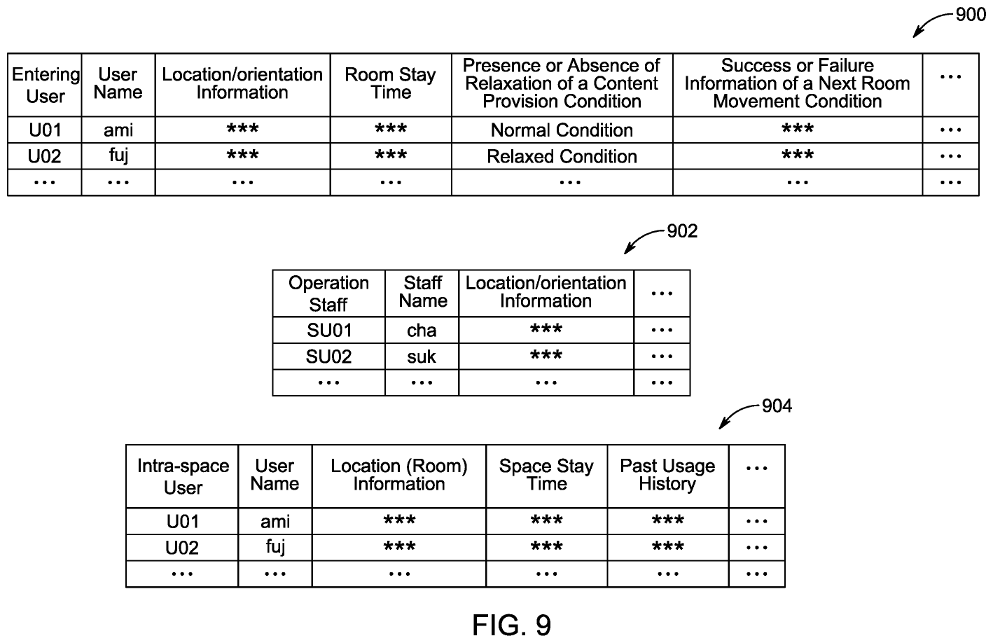

FIG. 4 is an example of a functional block diagram of the server device 10 related to the user assistance function. FIG. 5 is an example of a functional block diagram of a terminal device 20 (terminal device 20 on a transferor side) related to the user assistance function. FIG. 6 is an explanatory diagram of data in a user database 140. FIG. 7 is an explanatory diagram of data in an avatar database 142. FIG. 8 is an explanatory diagram of data in a content information storage unit 144. FIG. 9 is an explanatory diagram of data in a space state storage unit 146. In FIGS. 6-9, “***” indicates a state in which some information is stored, “-” indicates a state in which no information is stored, and “ . . . ” indicates similar repetition.

As illustrated in FIG. 4, the server device 10 includes a user database 140, an avatar database 142, a content information storage unit 144, a space state storage unit 146, a space drawing processing unit 150, a user avatar processing unit 152, a staff avatar processing unit 154, a location/orientation information identification unit 156, an assistance target detection unit 157, a drawing processing unit 158, a content processing unit 159, a dialog processing unit 160, an activity restriction unit 162, a condition processing unit 164, an extraction processing unit 166, a role allocation unit 167, a space information generation unit 168, a parameter updating unit 170, and a staff management unit 180. Some or all of the functions of the server device 10 to be described below may be realized by the terminal devices 20 as appropriate. Further, the division of the space state storage unit 146 from the user database 140 and the division of the parameter updating unit 170 from the space drawing processing unit 150 are for convenience of description, and some of the functional units may realize functions of other functional units. For example, the functions of the space drawing processing unit 150, the user avatar processing unit 152, the drawing processing unit 158, the location/orientation information identification unit 156, the content processing unit 159, the dialog processing unit 160, and the space information generation unit 168 may be realized by the terminal devices 20. Further, for example, a part or all of data in the user database 140 may be integrated with data in the avatar database 142, or may be stored in another database.

From the user database 140, the space state storage unit 146 can be realized by the server storage unit 12 illustrated in FIG. 1, and from the space drawing processing unit 150, the parameter updating unit 170 can be realized by the server control unit 13 illustrated in FIG. 1. Further, from the space drawing processing unit 150, a part of the parameter updating unit 170 (a functional unit that communicates with the terminal devices 20) can be realized by the server communication unit 11 together with the server control unit 13 illustrated in FIG. 1.

User information is stored in the user database 140. In the example illustrated in FIG. 6, the user information includes user information 600 related to general users and staff information 602 related to staff users.

In the user information 600, each user ID is associated with a user name, authentication information, a user avatar ID, location/orientation information, staff Yes-No information, purchase item information, purchase-related information, and the like. The user name is a name registered by a general user, and is arbitrary. The authentication information is information for indicating that a general user is a legitimate general user, and may include, for example, a password, a mail address, a date of birth, a countersign, biometric information, and the like. The user avatar ID is an ID for identifying a user avatar. The location/orientation information includes location information and orientation information of a user avatar (m1). The orientation information may be information indicating orientation of a face of a user avatar (m1). The location/orientation information and the like are information that can dynamically change in response to an operation input from a general user. In addition to the location/orientation information, it may include information indicating a movement of a limb or the like of a user avatar (m1), or information indicating a facial expression (for example, a mouth movement), a face or head orientation or sight direction (for example, eye orientation), or an object such as a laser pointer that indicates an orientation or coordinates in a space. The purchase item information may be information indicating a commodity or a service purchased by a general user among commodities and services sold in a virtual space.

The staff Yes-No information is information indicating whether or not a corresponding general user can become a staff user. The staff Yes-No information may indicate a staff ID when a general user, who can become a staff user, has become a staff user.

The purchase item information may be information indicating a commodity or a service purchased by a general user among commodities and services sold in a virtual space (that is, a past usage or provision history about commodities or services). The usage or provision history may include date and time and place of use or provision. The purchase-related information may be information indicating a commodity or a service that is among commodities or services sold in a virtual space and for which description, promotion, solicitation, or the like has been received (that is, past guidance history regarding a commodity or a service). The purchase item information and/or the purchase-related information may be information about one specific virtual space or information about multiple virtual spaces.

A commodity sold in a virtual space may be a commodity that can be used or provided in a virtual space, or may be adapted according to a content provided in a virtual space. For example, when a content provided in a virtual space is a concert, a commodity sold in the virtual space may be a binocular. Further, a service sold in a virtual space may be a service that can be used or provided in the virtual space, or may include provision of a content in the virtual space. Further, a service sold in a virtual space may be adapted according to a content provided in the virtual space. For example, when a content provided in a virtual space is a concert, a service sold in the virtual space may be an interaction (such as a handshake or a photograph) with an avatar of an artist.

In the staff information 602, each staff ID is associated with a staff name, authentication information, a staff avatar ID, location/orientation information, a staff point, and the like. The staff name is a name registered by a staff user, and is arbitrary. The authentication information is information indicating that a staff user is a legitimate staff user, and may include, for example, a password, a mail address, a date of birth, a countersign, biometric information, and the like. The staff avatar ID is an ID for identifying a staff avatar. The location/orientation information includes location information and orientation information of a staff avatar (m2). The orientation information may be information indicating orientation of a face of a staff avatar (m2). The location/orientation information and the like are information that can dynamically change in response to an operation input from a staff user. In addition to the location/orientation information, it may include information indicating a movement of a limb or the like of a staff avatar (m2), or information indicating a facial expression (for example, a mouth movement), a face or head orientation or sight direction (for example, eye orientation), or an object such as a laser pointer that indicates an orientation or coordinates in a space.

The staff point may be a parameter (an example of a parameter related to a quantity that plays a predetermined role) that increases each time a role of a staff avatar (a job as a staff) in virtual reality is fulfilled. That is, the staff point may be a parameter indicating a degree of work of a staff user in virtual reality. For example, the staff point of a staff user may be increased each time the staff user assists a general user in virtual reality via a corresponding staff avatar (m2). Or, the staff point of a staff user may be increased according to a time (working time) during which the staff user is in a state (operating state) ready to assist a general user in virtual reality via a corresponding staff avatar (m2).

The staff information 602 preferably further includes information about authority granted to a staff user. The authority information indicates authority related to a role granted to a staff avatar (m2) that supports (assists) user avatars (m1) active in a virtual space. There may be multiple types of authority, and in the example illustrated in FIG. 6, there are 3 types of authority: normal authority, operation authority, and supervisory authority. In a modified embodiment, there may be one type of authority, and in this case, the authority information may be unnecessary.

The normal authority is an authority granted to a normal staff user, and may be, for example, an authority that can provide various kinds of assistance for supporting a user avatar (m1) active in a virtual space. Various kinds of assistance are realized by providing assistance information (to be described later), but may also be realized in other forms (for example, demonstration or the like). The various kinds of assistance include at least one of various kinds of guidance for general users, guidance or sale of commodities or services that can be used or provided in a virtual space, handling complaints from general users, and various kinds of cautions or advice for general users. Guidance on commodities or services may include descriptions, advertisements, solicitations, and the like of the commodities or services. The normal authority may be an authority that only permits a predetermined part of the various kinds of assistance to be performed. In this case, the other part of the various kinds of assistance can be performed by a staff user who has the operation authority or the supervisory authority (to be described later).

The operation authority is, for example, an authority granted to a senior staff user who has more experience than a normal staff user or a dedicated staff user who has received a specific educational program (training program), and may be, for example, an authority to perform various operations related to a content provided in a virtual space. For example, in a case where various performances (for example, an appearance of a predetermined second object (m3) at an appropriate timing or an acoustic performance, or the like) are realized using a script or the like in a content provided in a virtual space, the operation authority may be an authority that various operations for the performances can be performed. Or, when a sale of a commodity or service is executed in a virtual space, the operation authority may include an authority to perform various operations of a cash register (a second object (m3)) related to the sale of the commodity or service, or an authority to manage the number of commodities or services provided, inventory, or the like. In this case, the operation authority may include an authority to enter the space (location (SP201)) corresponding to the backyard in the virtual space 80 illustrated in FIG. 2D. A staff user having the operation authority may also have the normal authority.

The supervisory authority is, for example, an authority granted to a supervisory staff user who is senior than a senior staff user, and may be, for example, an authority to supervise staff users in a virtual space, such as to manage all staff users to whom the normal authority or the operation authority described above is granted (for example, to change an authority or the like). Staff users having the supervisory authority may include, for example, a user who is a so-called game master. The supervisory authority may include an authority to arrange various second objects (m3) in a virtual space, an authority to select a content to be provided, an authority to handle a complaint from a general user, and the like. A staff user having the supervisory authority may also have the other authorities (the normal authority and the operation authority).

In the example illustrated in FIG. 6, a staff user marked with “O” is granted with the relevant authority. In this case, the staff user associated with the staff ID “SU01” is granted only the normal authority, and the staff user associated with the staff ID “SU02” is granted the normal authority and the operation authority.

The avatar database 142 stores avatar information about user avatars (m1) and staff avatars (m2). In the example illustrated in FIG. 7, the avatar information includes user avatar information 700 about general users and staff avatar information 702 about staff users.

In the user avatar information 700, each user avatar ID is associated with a face, a hairstyle, clothing, and the like. Information related to appearance such as a face, a hairstyle, or clothing is a parameter characterizing a user avatar, and is set by a general user. For example, an ID may be assigned to each type of information related to appearance such as a face, a hairstyle, or clothing of an avatar. Further, regarding a face, a part ID may be prepared for each of types including a face shape, eyes, mouth, nose, and the like, and information related to the face may be managed by a combination of the IDs of parts forming the face. In this case, information related to appearance such as a face, a hairstyle, or clothing can function as avatar drawing information. That is, based on the IDs related to the appearance associated with each user avatar ID, each user avatar (m1) can be drawn not only on the server device 10 but also on the terminal device 20 side.

In the staff avatar information 702, each staff avatar ID is associated with a face, a hairstyle, clothing, and the like. Information related to appearance such as a face, a hairstyle, or clothing is a parameter characterizing a staff avatar, and is set by a staff user. Similar to the case of the user avatar information 700, information related to appearance such as a face, or a hairstyle may be managed by a combination of IDs of respective parts, and may function as avatar drawing information.

In this way, in the present embodiment, basically, one user ID is associated with one general user, and a user avatar ID is associated with one user ID. Therefore, a state in which certain information is associated with one general user, a state in which the information is associated with the one user ID, and a state in which the information is associated with a user avatar ID associated with the one user ID are synonymous with each other. This also applies to staff users. Therefore, for example, unlike the example illustrated in FIG. 6, the location/orientation information of a user avatar (m1) may be stored in association with a user avatar ID related to the user avatar (m1), and, similarly, the location/orientation information of a staff avatar (m2) may be stored in association with a staff avatar ID related to the staff avatar (m2). In the following description, a general user and a user avatar (m1) associated with the general user are in a mutually readable relationship.

The content information storage unit 144 stores various kinds of information about specific contents that can be provided in a virtual space. For example, for each specific content, a content provision location, which is a provision location of the content, details, and the like, are stored.

In the example illustrated in FIG. 8, each content ID is associated with a content provision location (indicated as a “provision location” in FIG. 8), details of the content (referred to as “details” in FIG. 8).

A content provision location is a location in a virtual space and includes a location where a general user can receive content provision via the content processing unit 159. That is, a content provision location includes a location where provision of a specific content can be received. A content provision location may be defined by a coordinate value of a point. However, typically, it may be defined by multiple coordinate values forming a collection of regions or spatial portions. Further, a content provision location may be a location on a plane, or may be a spatial location (that is, a location represented by a three-dimensional coordinate system including a height direction). A unit of a specific content associated with one content provision location is defined as one specific content (a unit of a specific content). Therefore, for example, even when two types of videos can be viewed at one certain content provision location, all the two types of videos are one specific content.

A content provision location may typically be set according to an attribute of a corresponding specific content. For example, in the example illustrated in FIG. 2A, content provision locations are locations in the virtual space that can be entered through gates. In the example illustrated in FIG. 2B, content provision locations are respectively the first location (SP11) to the eighth location (SP18) in the virtual space that can be entered through gates. Similarly, in the example illustrated in FIG. 2C, content provision locations are respectively the locations (SP21,SP22, SP23) in the virtual space that can be entered through gates. A content provision location may be defined by a specific URL (Uniform Resource Locator). In this case, by accessing the specific URL, a general user or the like can move a user avatar (m1) or the like to the content provision location. In this case, a general user can access a specific URL to receive provision of a specific content on a browser of a terminal device 20.

Details of a content may include information such as a content name, an overview, a creator, and the like.

Further, the content information storage unit 144 may store information indicating a condition (hereinafter, also referred to as a “content provision condition”) to be satisfied in order to receive provision of specific contents at respective content provision locations. A content provision condition may be set for each content ID. As illustrated in FIGS. 2B and 2C, a content provision condition is preferably set in a virtual space such that provision of multiple specific contents that are meaningful as a whole can be sequentially received through a series of content provision locations. A content provision condition is arbitrary and may be appropriately set by the operator according to characteristics or the like of a specific content to be provided. Further, a content provision condition may be set or changed by a staff user having the supervisory authority described above.

For example, a content provision condition related to one certain content provision location may include receiving provision of specific contents at one or more other specific content provision locations. In this case, since the order of provision of a series of specific contents can be controlled, it is possible to efficiently enhance an experience effect (for example, a learning effect of education) of a general user by receiving the provision of the series of specific contents. Further, a content provision condition related to one certain content provision location may be that provision of specific contents at one or more other specific content provision locations has been received and assignments set at the one or more other specific content provision locations have been cleared. In this case, an assignment set at one or more other specific content provision locations may be an assignment associated with a specific content provided at the one or more other specific content provision locations. For example, in a case of a content for learning, a assignment for effect confirmation (for example, a correct answer rate with respect to a simple test or quiz) may be set.

Two or more types content provision conditions may be set. For example, in the example illustrated in FIG. 8, only a normal condition is set for a content ID “CT01,” and a normal condition and a relaxed condition are set for a content ID “CT02.” In this case, with respect to a specific content corresponding to the content ID “CT02,” either the normal condition or the relaxed condition is selectively applied. A relaxed condition is a condition that is more easily satisfied than a normal condition. For example, under a normal condition, an assignment needs to be cleared within a predetermined time ΔT1, whereas under a relaxed condition, the assignment only needs to be cleared within a predetermined time ΔT2, which is significantly longer than the predetermined time ΔT1. Or, under a relaxed condition, a difficulty level of an assignment to be cleared is lower than that under a normal condition. A content ID to which two or more types of content provision conditions are assigned may be set or changed by a staff user having the supervisory authority described above.

In the following, in the present embodiment, as an example, in a virtual space, when N is an integer of 3 or more, it is assumed that N content provision locations (N specific contents) are set. Then, it is assumed that the N specific contents that can be provided at the N content provision locations are contents that can be provided in the order of from the first content to the N-th content. Therefore, it is assumed that a general user cannot receive the provision of the (N−1)-th specific content until all the provisions of the specific contents up to the (N−2)-th specific content have been received.

The space state storage unit 146 stores space state information of a virtual space. The space state information indicates states related to activities of user avatars (m1), states related to activities (activities related to roles) of staff avatars (m2), and the like in the virtual space.

The space state information of a virtual space may include space state information regarding a state in a space portion related to a content provision location, and may further include space state information regarding a state in a space portion related to a predetermined support location.

A content provision location is as described above. A predetermined support location is a location other than a content provision location in a virtual space, and is a location where a general user is likely to need assistance from a staff user. For example, a predetermined support location may include a vicinity of an entrance or the like related to a content provision location. For example, in the examples illustrated in FIGS. 2A-2C, predetermined support locations are the locations (SP1, SP2), or the location (SP20) (see FIG. 2C), or the like.

In the following, unless otherwise specified, the space state information means space state information regarding a state in a space portion related to a content provision location. Further, in the following, a space portion related to each content provision location in a virtual space is defined as a room, and can be described using a URL for general users. Users accessing the same room are managed as a session associated with the same room. In some cases, an avatar enters into a space portion related to a room. That an avatar enters a space portion related to a room may be expressed as entering the room. There is a limit to the number of users who can access one room at the same time from a point of view of processing capacity. However, there may be a process that duplicates rooms with the same design and distributes the load. All the rooms connected to each other are also referred to as a “world.”

In the example illustrated in FIG. 9, the space state information is managed for each content provision location (room) and for the entire virtual space. Specifically, the space state information includes user state information 900 related to general users, staff state information 902 related to staff users, and virtual space information 904 related to the virtual space. For the user state information 900 and the staff state information 902, space state information related to one certain content provision location is indicated. However, unless otherwise specified, the same may apply to space state information related to a predetermined support location.

The user state information 900 is set for each content provision location (room), and the user state information 900 illustrated in FIG. 9 relates to one content provision location. For example, in the example illustrated in FIG. 2B, the staff state information 902 is set for each of the locations from the first location (SP11) to the eighth location (SP18). Similarly, in the example illustrated in FIG. 2C, it is set for each of the locations (SP21,SP22, SP23).

In the user state information 900, each entering user is associated with a user name, location/orientation information, a room stay time, presence or absence of relaxation of a content provision condition, success or failure information of a next room movement condition, and the like. The entering user is a general user related to a user avatar (m1) located at a content provision location, and information about the entering user may be any information (a user ID, a user avatar ID, or the like) capable of identifying the general user. The user name is a user name based on the user information described above. Since the user name is information associated with the entering user, the user name may be omitted from the user status information 900. The location/orientation information is location/orientation information of a user avatar (m1). Since the entering user is a general user related to a user avatar (m1) located at a content provision location, the location information of the user avatar (m1) corresponds to a content provision location (when it is defined by multiple coordinate values, one of the multiple coordinate values). In other words, when the location information of one user avatar (m1) does not correspond to the content provision location, the general user associated with the one user avatar (m1) is excluded from entering users. The location information of a user avatar (m1) is particularly useful when one content provision location is defined by multiple coordinate values (that is, when a relatively large region or an entire space portion is a content provision location). In this case, the location information can indicate where it is located in a relatively large space portion.

The room stay time corresponds to a stay time it is located at a content provision location. The room staying time may be used for determining a next room movement condition, or the like.

Presence or absence of relaxation of a content provision condition is information indicating which of the normal condition and the relaxed condition of the content provision conditions in the content information storage unit 144 described above with reference to FIG. 8 is applied. Which of the normal condition and the relaxed condition is to be applied may be automatically set according to a predetermined rule, or there may be a case where it is relaxed by the condition processing unit 164 to be described later. For example, when a general user is relatively young (for example, is an elementary school student or the like) or when the room stay time of a general user is relatively long, the relaxed condition may be initially automatically set for a general user. Further, for a specific general user, a condition related to a room stay time may be removed as a relaxed condition. For example, an event timer that can be set for each general user is not set or may be ignored for a specific general user.

The success or failure information of a next room movement condition indicates whether or not an entering user has satisfied a condition (next room movement condition) to be satisfied when moving to a next content provision location. The next room movement condition may be arbitrarily set based on the above-described content provision condition. In the present embodiment, the next room movement condition is the same as a content provision condition set for a content provision location related to the next room. Therefore, for a general user (entering user), when the content provision condition set for the content provision location related to the next room is satisfied, the next room movement condition is satisfied. Success or failure information of a next room movement condition related to a predetermined support location also may indicate whether or not a condition (next room movement condition) to be satisfied when moving to a next content provision location (for example, a first content provision location) has been satisfied.

The next room movement condition applies to a general user (user avatar (m1)) and does not apply to a staff user (staff avatar (m2)). Therefore, a staff avatar (m2) can, in principle, freely move to each room.

The staff state information 902 may be set for each virtual space, or may be set for each entire room (hereinafter, also referred to as a “content provision virtual space unit”) related to a group of content provision locations. For example, in the example illustrated in FIG. 2B, the staff state information 902 relates to all the space portions that are respectively related to the locations from the first location (SP11) to the eighth location (SP18) (a content provision virtual space unit). Similarly, in the example illustrated in FIG. 2C, the staff state information 902 relates to all the pace portions that are respectively related to locations (SP21, SP22, SP23) (a content provision virtual space unit).

In the staff state information 902, an operation staff is associated with a staff name, and location/orientation information. An operation staff is a staff user related to a staff avatar (m2) located at a content provision location, and information about an operation staff may be any information (a staff ID, a staff avatar ID, or the like) that can identify the staff user.

Similar to the staff state information 902, the virtual space information 904 may be set for each virtual space or may be set for each content provision virtual space unit. Specifically, when multiple independent content provision virtual space units are prepared, the virtual space information 904 may be set for each of such independent content provision virtual space units. Further, when the virtual reality generation system 1 simultaneously handles the virtual space illustrated in FIG. 2B and the virtual space illustrated in FIG. 2C, virtual space information 904 for the virtual space illustrated in FIG. 2B and virtual space information 904 for the virtual space illustrated in FIG. 2C may be set respectively.

In the virtual space information 904, an intra-space user is associated with a user name, location information, a space stay time, a past usage history, and the like. The user name is as described above and may be omitted.

An intra-space user is a general user related to a user avatar (m1) located at any one of content provision locations in a content provision virtual space unit, and may be generated based on information of an entering user of the user state information 900.

The location information is information indicating in which content provision location (room) in a content provision virtual space unit it is located, and may be information coarser than the location/orientation information of the user state information 900.

The space stay time is a time accumulated while located in a content provision virtual space unit, and may be generated based on a room stay time of the user state information 900. Similar to the room stay time of the user state information 900, the space stay time may be used for determining a next room movement condition or the like. Further, similar to the room stay time of the user state information 900, the space stay time may be used to create a certificate of completion or the like showing an activity result in a virtual space.

The past usage history is a past usage history related to a content provision virtual space unit. The past usage history may include information indicating a date and time and a progress status such as to which content provision location in a content provision virtual space unit it has advanced. As will be described later, the past usage history may be used when a role related to a staff user is assigned to a general user. Or, the past usage history may be used in order to allow a general user who can re-enter after interruption or the like to resume from the middle of the last time.

The space drawing processing unit 150 draws a virtual space based on drawing information of a virtual space. The drawing information of a virtual space is generated in advance, but may be updated afterward or dynamically. Each location in a virtual space may be defined in a spatial coordinate system. Although a method for drawing a virtual space is arbitrary, it may be realized, for example, by mapping a field object or a background object onto an appropriate plane, curved surface, or the like.

The user avatar processing unit 152 executes various kinds of processing related to a user avatar (m1). The user avatar processing unit 152 includes an operation input acquisition unit 1521 and a user action processing unit 1522.

The operation input acquisition unit 1521 acquires operation input information by a general user. The operation input information by a general user is generated via the input unit 24 of a terminal device 20 described above.

The user action processing unit 1522 determines a location and an orientation of a user avatar (m1) in a virtual space based on the operation input information acquired by the operation input acquisition unit 1521. Location/orientation information of a user avatar (m1) indicating a location and an orientation determined by the user action processing unit 1522 may be stored in association with, for example, a user ID (see the user information 600 of FIG. 6). Further, the user action processing unit 1522 may determine various movements of a hand, a face, or the like of a user avatar (m1) based on the operation input information. In this case, such movement information may also be stored along with the location/orientation information of the user avatar (m1).

In the present embodiment, the user action processing unit 1522 moves each of user avatars (m1) in a virtual space under a restriction by the activity restriction unit 162 to be described later. That is, the user action processing unit 1522 determines a location of a user avatar (m1) under a restriction by the activity restriction unit 162 to be described later. Therefore, for example, when the activity restriction unit 162 restricts a movement of a user avatar (m1) to a content provision location, the user action processing unit 1522 determines a location of the user avatar (m1) in such a manner that a movement of the user avatar (m1) to the content provision location is not realized.

Further, the user action processing unit 1522 moves each of user avatars (m1) in a virtual space according to a predetermined law corresponding to a physical law in a real space. For example, when there is a second object (m3) corresponding to a wall in a real space, a user avatar (m1) may not be able to pass through the wall. Further, a user avatar (m1) receives an attractive force corresponding to gravity from a field object, and may not be able to float in the air for a long time unless wearing a special instrument (such as an instrument that produces a lifting force).

Here, as described above, the function of the user action processing unit 1522 can also be realized by a terminal device 20 instead of the server device 10. For example, a movement in a virtual space may be realized in such a manner that an acceleration, a collision, and the like are expressed. In this case, each user can also cause a user avatar (m1) to jump and move by pointing (instructing) a location. However, determination regarding a restriction regarding a wall surface or a movement may be realized by the terminal control unit 25 (the user action processing unit 1522). In this case, the terminal control unit 25 (the user action processing unit 1522) performs determination processing based on restriction information provided in advance. In this case, the location information may be shared with other users who need the information via the server device 10 by real-time communication based on Web Socket or the like.

The staff avatar processing unit 154 executes various kinds of processing related to a staff avatar (m2). The staff avatar processing unit 154 includes an operation input acquisition unit 1541, a staff action processing unit 1542, and an assistance information provision unit 1544.

An operation input acquisition unit 1541 acquires operation input information by a staff user. The operation input information by a staff user is generated via the input unit 24 of a terminal device 20 described above.

The staff action processing unit 1542 determines a location and an orientation of a staff avatar (m2) in a virtual space based on the operation input information acquired by the operation input acquisition unit 1541. Location/orientation information of a staff avatar (m2) indicating a location and an orientation determined by the staff action processing unit 1542 may be stored in association with, for example, a staff ID (see the staff information 602 of FIG. 6). Further, the staff action processing unit 1542 may determine various movements of a hand, a face, or the like of a staff avatar (m2) based on the operation input information. In this case, such movement information may also be stored along with the location/orientation information of the staff avatar (m2).

In present embodiment, unlike the user action processing unit 1522 described above, the staff action processing unit 1542 moves each of staff avatars (m2) in a virtual space without following a predetermined law corresponding to a physical law in a real space. For example, even when there is a second object (m3) corresponding to a wall in a real space, a staff avatar (m2) may be able to pass through the wall. Further, a staff avatar (m2) may be able to float in the air for a long time without the need of wearing a special instrument (such as an instrument that produces a lifting force). Or, a staff avatar (m2) may be capable of so-called teleportation (warp), becoming gigantic, and the like.

Further, a staff avatar (m2) may be able to realize a movement or the like that cannot be performed by a user avatar (m1). For example, unlike a user avatar (m1), a staff avatar (m2) may be able to move a second object (m3) that corresponds to a very heavy object (for example, a bronze statue or a building). Or, unlike a user avatar (m1), a staff avatar (m2) may be able to transfer or convert a predetermined item. Or, unlike a user avatar (m1), a staff avatar (m2) may be able to move to special space portions in a virtual space for a meeting or the like (for example, space portions corresponding to various staff rooms as illustrated in FIG. 2D).

Further, the staff action processing unit 1542 may change a degree of freedom of a movement of a staff avatar (m2) based on information about the authority granted to the staff user. For example, the staff action processing unit 1542 may grant a highest degree of freedom to a staff avatar (m2) related to a staff user having the supervisory authority, and may grant a next highest degree of freedom to a staff avatar (m2) related to a staff user having the operation authority.

The assistance information provision unit 1544 provides predetermined information to a general user in response to a predetermined input by a staff user. The predetermined information may be any information that may be useful for a general user, and may include, for example, an advice or tips for satisfying a next room movement condition, information for resolving dissatisfaction or anxiety of a general user, and the like. When the predetermined information is diverse, a predetermined input from a staff user may include an input specifying a type of predetermined information to be provided. For example, the predetermined information may be output in any manner via a terminal device 20 of a general user. For example, the predetermined information may be output by voice, video, or the like via a terminal device 20. When the provision of the predetermined information is realized by a dialog between a general user and a staff user, the provision of the predetermined information is realized by a second dialog processing unit 1602 to be described later.

In the present embodiment, the predetermined information is assistance information that allows various types of assistance for a general user to be realized. Then, the assistance information provision unit 1544 provides the assistance information to some or each of the general users via a staff avatar (m2) based on the user state information 900 (see FIG. 9) associated with each of the general users.

In this way, in the present embodiment, a staff user can provide various kinds of assistance information to a general user via a staff avatar (m2) by the assistance information provision unit 1544 by performing various predetermined inputs.

For example, a staff user provides assistance information including an advice or tip for satisfying a next room movement condition to a general user who has not satisfied the next room movement condition. For example, a staff user may describe a next room movement condition for a general user related to a user avatar (m1) who cannot pass through an entrance to a next content provision location, or may advise the user so as to satisfy the next room movement condition. Or, in a case where an entrance to a next content provision location cannot be passed through when an assignment has not been cleared, a staff user may provide a hint or the like for clearing the assignment.

Further, the assistance information may be a demonstration of a practical skill, a sample, or the like based on a movement of a staff user. For example, when an assignment related to a specific content involves a specific body movement, a staff user may indicate the specific body movement to a general user via a staff avatar (m2). Or, as in the example illustrated in FIG. 2C, when it is useful to receive specific contents in a predetermined order, a staff user may advise to proceed in the predetermined order.

In the present embodiment, the assistance information provision unit 1544 may change an ability of providing assistance information by a staff user based on information about the authority granted to the staff user. For example, the assistance information provision unit 1544 may grant a staff user who has the supervisory authority the authority to provide assistance information to all general users, and grant a staff user who has the operation authority the authority to provide assistance information only to a general user of a user avatar (m1) located in a specific space portion. Further, the assistance information provision unit 1544 may grant a staff user who has the normal authority the authority to provide only standard assistance information prepared in advance, or the authority to provide only assistance information for navigating a user avatar (m1) to a predetermined guidance location or the like so that assistance information can be obtained from a staff avatar (m2) related to the staff user who has the supervisory authority or the operation authority.

The location/orientation information identification unit 156 identifies location information of a user avatar (m1) and location information of a staff avatar (m2). The location/orientation information identification unit 156 may identify location information of each of a user avatar (m1) and a staff avatar (m2) based on information from the user action processing unit 1522 and the staff action processing unit 1542 described above.

The assistance target detection unit 157 detects, from user avatars (m1) active in a virtual space, a user avatar (m1) related to a general user who is highly likely to need assistance information (hereinafter, such a user avatar (m1) is also referred to as an “assistance target user avatar (m1)”). In the present embodiment, the assistance target detection unit 157 may detect an assistance target user avatar (m1) based on data in the space state storage unit 146. For example, the assistance target detection unit 157 may detect an assistance target user avatar (m1) based on a user avatar (m1) with a relatively long room stay time, a user avatar (m1) with few movements, a user avatar (m1) with movements that suggest hesitation, and the like. For example, when there is a signal from a user avatar (m1) such as raising a hand when assistance information is needed, the assistance target detection unit 157 may detect the user avatar (m1) as an assistance target based on such a signal.

It is also possible to output (detect) an assistance target user avatar (m1) by inputting data in the space state storage unit 146 using artificial intelligence. In the case of artificial intelligence, it can be realized by implementing a convolutional neural network obtained by machine learning. In machine learning, for example, using data (historic data) in the space state storage unit 146, a weight or the like of a convolutional neural network that minimizes an error related to a detection result of an assistance target user avatar (m1) (that is, an error that a user avatar (m1) that does not actually need assistance information is detected as an assistance target user avatar (m1)) is learned.

Upon detecting an assistance target user avatar (m1), the assistance target detection unit 157 may output an instruction to the drawing processing unit 158 (to be described later) so that the assistance target user avatar (m1) is drawn in a predetermined drawing mode.

In the present embodiment, when an assistance target user avatar (m1) is detected, the assistance target detection unit 157 may generate additional information such as the necessity (urgency) of providing assistance information, and an attribute of necessary assistance information. For example, the additional information may include information indicating whether or not assistance information via dialog by the second dialog processing unit 1602 (to be described later) is necessary or whether or not it is sufficient with provision of one-way assistance information.

Further, in response to a direct assistance request from a general user (an assistance request from an assistance request unit 250 to be described later), the assistance target detection unit 157 may detect a user avatar (m1) that has generated the assistance request as an assistance target user avatar (m1).

The drawing processing unit 158 (an example of a medium drawing processing unit) draws each virtual reality medium (for example, a user avatar (m1), or a staff avatar (m2)) that can move in a virtual space. Specifically, the drawing processing unit 158 generates an image to be displayed on a terminal device 20 of a user based on the avatar drawing information (see FIG. 7), the location/orientation information of a user avatar (m1) or the location/orientation information of a staff avatar (m2), and the like.

In the present embodiment, the drawing processing unit 158 includes a terminal image generation unit 1581 and a user information acquisition unit 1582.

For each user avatar (m1), based on the location/orientation information of the each user avatar (m1), the terminal image generation unit 1581 generates an image to be displayed on a terminal device 20 of a general user associated with the each user avatar (m1) (hereinafter, this image is also referred to as a “terminal image for a general user” when distinguished from a terminal image for a staff user to be described later). Specifically, based on the location/orientation information of one user avatar (m1), the terminal image generation unit 1581 generates, as a terminal image, an image of a virtual space viewed from a virtual camera of a location and an orientation corresponding to the location/orientation information (an image that cuts out a part of the virtual space). In this case, when the location and the orientation of the virtual camera match the location and the orientation corresponding to the location/orientation information, the field of view of the virtual camera substantially matches the field of view of the user avatar (m1). However, in this case, the user avatar (m1) does not appear in the field of view from the virtual camera. Therefore, when generating a terminal image showing the user avatar (m1), the location of the virtual camera may be set on a back side of the user avatar (m1). Or, the location of the virtual camera may be arbitrarily adjustable by the corresponding general user. When generating such a terminal image, the terminal image generation unit 1581 may execute various kinds of processing (such as bending field objects) in order to give a sense of depth and the like. Further, when generating a terminal image showing the user avatar (m1), in order to reduce the load of the drawing processing, the user avatar (m1) may be drawn in a relatively simple manner (for example, in a form of a two-dimensional sprite).

Further, similarly, for each staff avatar (m2), based on the location/orientation information of the each staff avatar (m2), the terminal image generation unit 1581 generates an image to be displayed on a terminal device 20 of a staff user associated with the each staff avatar (m2) (hereinafter, this image is also referred to as a “terminal image for a staff user” when distinguished from a terminal image for a general user described above).

When another user avatar (m1) or staff avatar (m2) is located in the field of view from the virtual camera, the terminal image generation unit 1581 generates a terminal image including the another user avatar (m1) or staff avatar (m2). However, in this case, in order to reduce the load of the drawing processing, the another user avatar (m1) or staff avatar (m2) may be drawn in a relatively simple manner (for example, in a form of a two-dimensional sprite).

Further, the terminal image generation unit 158 may realize processing to make an utterance state easy to understand.by reproducing a movement of a speaker's mouth or emphasizing a size of the speaker's head or the like. Such processing may be realized in cooperation with the dialog processing unit 160 to be described later.

Here, as described above, the function of the terminal image generation unit 1581 can also be realized by a terminal device 20 instead of the server device 10. In this case, for example, the terminal image generation unit 1581 receives the location/orientation information generated by the staff avatar processing unit 154 of the server device 10, the information that can identify an avatar to be drawn (for example, a user avatar ID or a staff avatar ID), and the avatar drawing information related to the avatar to be drawn (see FIG. 7) from the server device 10, and, based on the received information, draws an image of each avatar. In this case, a terminal device 20 may store part information for drawing each part of an avatar in the terminal storage unit 22, and may draw the appearance of each avatar based on the part information and the avatar drawing information (ID of each part) of a drawing target acquired from the server device 10.

In the present embodiment, the terminal image generation unit 1581 draws a staff avatar (m2) in a terminal image for a general user (an example of a display image for a user of a first attribute) or a terminal image for a staff user (an example of a display image for a user of a second attribute) in a manner identifiable from a user avatar (m1).

Specifically, the terminal image generation unit 1581 draws multiple staff avatars (m2) arranged in a virtual space in association with a common visible feature. As a result, based on the common visible feature, whether or not each user is a staff user can be easily identified. For example, when one avatar is drawn in association with the common visible feature, each user can easily recognize that the one avatar is a staff avatar (m2). In this way, the common visible feature may be arbitrary as long as it has such an identification function. However, the common visible feature is preferably sized to be noticeable at a glance so as to have a high discrimination ability.

For example, the common visible feature is common clothing (uniform) or an accessory (for example, a staff-specific armband or batch, dedicated security card, or the like). Further, the common visible feature may be a text such as “Staff,” which is drawn in a vicinity of a staff avatar (m2). In the present embodiment, as an example, the common visible feature is a uniform.

The common visible feature is preferably prohibited from being changed by each of the staff users. That is, preferably, each staff user is not allowed to modify or arrange the common visible feature so that the commonality is not compromised. As a result, it is possible to reduce the possibility that the identification function related to the common visible feature is damaged due to a loss of commonality. However, the common visible feature may be modified or arranged by a specific staff user (for example, a staff user having the supervisory authority). In this case, since the common visible feature after modification or arrangement is applied to all corresponding staff users, the commonality is not impaired.

Further, the common visible feature may be a part of an item. For example, when an item associated with the common visible feature is a jacket, and a ribbon or a button of the jacket is arrangeable, the common visible feature is a part of the jacket excluding the arrangeable ribbon or button. Further, when an item associated with the common visible feature is a hairstyle with a hat, and the hairstyle of the hairstyle with the hat can be arranged (that is, the hat is prohibited from being arranged), the common visible feature is a portion of the hairstyle with the hat excluding the hairstyle (that is, the hat portion). Of an item related to the common visible feature, such a portion that can be arranged or portion that is prohibited from being arranged may be specified in advance. As a result, exhibition of individuality (individuality due to an arranged portion) related to appearance of each staff avatar (m2) can be expected, while the identification function of the common visible feature is maintained. In this case, a predetermined penalty may be imposed when a staff user edits a portion of an item related to the common visible feature that is prohibited from being arranged (that is, the common visible feature). For example, the predetermined penalty may be such that the arranged item cannot be used (for example, worn) or cannot be stored (cannot be stored in the server device 10). Or, the predetermined penalty may include that an evaluation result of an evaluation unit 1803 of the staff management unit 180 (to be described later) is significantly reduced. Further, an item related to the common visible feature may be prohibited from being exchanged or transferred to another user.

The common visible feature may be different depending on an attribute (staff attribute) of a staff user. In other words, the common visible feature may be common for each staff attribute. A staff attribute may be an attribute corresponding to, for example, authority information (three types of authority including the normal authority, the operation authority, and the supervisory authority), or may be an attribute corresponding to a finer granularity (for example, a more detailed role or a room in which it is located, and the like). As a result, each user can determine an attribute of a staff user (a staff attribute) based on the type of the common visible feature. Also in this case, staff avatars (m2) related to staff users of the same staff attribute are drawn in association with the common visible feature. Further, a staff user may be able to select any type (for example, a desired type) from multiple types of an object (such as a uniform).

The terminal image generation unit 1581 preferably draws a terminal image for a general user and a terminal image for a staff user in different modes. In this case, even when the location/orientation information of a user avatar (m1) and the location/orientation information of a staff avatar (m2) completely match each other, the terminal image for the general user and the terminal image for the staff user are drawn in different modes. For example, the terminal image generation unit 1581 may draw predetermined user information acquired by the user information acquisition unit 1582 (to be described later) in a terminal image for a staff user. In this case, a method for drawing the predetermined user information is arbitrary. However, for example, it may be drawn in association with a user avatar (m1) of a general user. For example, the predetermined user information may be superimposed on or drawn in a vicinity of a user avatar (m1) or may be drawn together with a user name. Further, in this case, the predetermined user information may be, for example, information that is useful for the role of a staff user and is normally invisible (for example, the success or failure information of a next room movement condition). Further, the terminal image generation unit 1581 may draw a user avatar (m1) that has satisfied a next room movement condition and a user avatar (m1) that has not satisfied the next room movement condition in different modes in a terminal image for a staff user based on the success or failure information of the next room movement condition (see FIG. 9). In this case, a staff user can easily distinguish between a user avatar (m1) that can move to a next room and a user avatar (m1) that cannot move to the next room. As a result, a staff user can efficiently provide assistance information to a general user related to the user avatar (m1) that cannot move to the next room.

Further, when generating a terminal image for a staff user, the terminal image generation unit 1581 may change a disclosure range of normally invisible information based on the information about the authority granted to the staff user. For example, the terminal image generation unit 1581 may grant the widest disclosure range to a staff avatar (m2) related to a staff user having the supervisory authority, and may grant the next widest disclosure range to a staff avatar (m2) related to a staff user having the operation authority.

In the present embodiment, when an assistance target user avatar (m1) is detected by the assistance target detection unit 157 as described above, the terminal image generation unit 1581 draws the assistance target user avatar (m1) in a predetermined drawing mode in a terminal image for a staff user.

The predetermined drawing mode may include highlighting (for example, displaying with flashing, in red, and the like) for easy recognition by a staff user. In this case, a staff user can easily find the assistance target user avatar (m1).

Or, the predetermined drawing mode may be accompanied by an appearance of a superimposed sub-image (see sub-image (G156) in FIG. 15). In this case, the terminal image generation unit 1581 superimposes and displays a sub-image showing an assistance target user avatar (m1) in a terminal image for a specific staff user. In this case, the specific staff user may be a staff user related to a staff avatar (m2) close to the assistance target user avatar (m1), or may be a staff user who has the authority to provide assistance information to the assistance target user avatar (m1). When multiple assistance target user avatars (m1) are detected by the assistance target detection unit 157, multiple sub-images may be generated. Further, a sub-image may be displayed in a mode such that a frame or the like blinks.

Further, the predetermined drawing mode may be different depending on an attribute of required assistance information. For example, an assistance target user avatar (m1) who needs assistance information due to “having not finished receiving provision of a specific content” and an assistance target user avatar (m1) who needs assistance information due to “having finished receiving provision of a specific content but having not been able to submit an assignment,” may be drawn in different predetermined drawing modes. In this case, by making a relationship between a predetermined drawing mode and needed assistance information a rule, a staff user can easily recognize which assistance information is useful for an assistance target user avatar (m1) by looking at the drawing mode of the assistance target user avatar (m1).

Further, when the above-described additional information is generated by the assistance target detection unit 157, according to the additional information, the terminal image generation unit 1581 may determine a staff user (for example, the above-described specific staff user) who is to provide assistance information to an assistance target user avatar (m1). For example, when an attribute indicated by the additional information (attribute of needed assistance information) is a complaint-handling dialog, the terminal image generation unit 1581 may determine a staff user having the supervisory authority as a staff user to provide assistance. In this case, the terminal image generation unit 1581 may superimpose and display a sub-image showing the assistance target user avatar (m1) in the terminal image for the staff user having the supervisory authority.

The user information acquisition unit 1582 acquires the predetermined user information described above. As described above, the predetermined user information is information to be drawn in a terminal image for a staff user and is information that is not displayed in a terminal image for a general user.

The user information acquisition unit 1582 may acquire predetermined user information for each staff user. In this case, the predetermined user information can be different for each staff user. This is because, for each staff user, information useful for the role of the staff user may be different.

For example, regarding a terminal image for a staff user, when a user avatar (m1) is included in the terminal image, the user information acquisition unit 1582 may acquire predetermined user information corresponding to a general user related to the user avatar (m1) based on the user information related to the user avatar (m1) (for example, see the user information 600 in FIG. 6). In this case, for example, when the user information 600 of FIG. 6 is used, the user information acquisition unit 1582 may acquire the purchase item information and/or the purchase-related information in the user information 600 or information generated based on the purchase item information and/or the purchase-related information as the predetermined user information. When the purchase item information or information generated based on the purchase item information (for example, a part of the purchase item information, user preference information obtained from the purchase item information, or the like) is acquired as the predetermined user information, a staff user can understand what kind of item is already possessed by the general user related to the assistance target user avatar (m1). As a result, a staff user can generate appropriate assistance information for the general user, such as recommending purchase of an item not possessed by the general user. Further, when the purchase-related information or information generated based on the purchase-related information (for example, user preference information or the like) is acquired as the predetermined user information, a staff user can easily determine what kind of preference the general user related to the assistance target user avatar (m1) has. For example, a staff user can easily understand a preference or behavioral tendency of a general user by understanding facts such as that an item is advertised but has not been purchased or that an item is purchased after repeated advertisements. As a result, a staff user can generate appropriate assistance information, such as advertising an item only to a general user for whom advertising is useful.

The content processing unit 159 provides a specific content to a general user at each content provision location. For example, the content processing unit 159 may output a specific content on a terminal device 20 via a browser. Or, the content processing unit 159 may output a specific content on a terminal device 20 via a virtual reality application installed on the terminal device 20.

In the present embodiment, as described above, basically, a specific content provided by the content processing unit 159 differs for each content provision location. For example, a specific content provided at a content provision location may be different from a specific content provided at another content provision location. However, it is also possible that the same specific content may be provided at multiple content provision locations.

The dialog processing unit 160 includes a first dialog processing unit 1601 and a second dialog processing unit 1602.

The first dialog processing unit 1601 enables a dialog between general users via the network 3 based on inputs from multiple general users. A dialog may be realized in a text and/or voice chat format via the corresponding user avatars (m1). This enables a dialog between general users. The text is output to the display units 23 of the terminal devices 20. For example, the text may be output separately from an image related to a virtual space, or may be output superimposed on an image related to a virtual space. A dialog by text output to the display units 23 of the terminal devices 20 may be realized in a form that is open to an unspecified number of users, or may be realized in a form that is open only to specific general users. This also applies to a voice chat.

In the present embodiment, based on respective locations of user avatars (m1), the first dialog processing unit 1601 may determine multiple general users who can have a dialog with each other. For example, when a distance between one user avatar (m1) and another user avatar (m1) is equal to or less than a predetermined distance (d1), the first dialog processing unit 1601 may enable a dialog between the general users associated with the one user avatar (m1) and the other user avatar (m1). The predetermined distance (d1) may be appropriately set according to a size of a virtual space or each room, or the like, and may be fixed or variable. Further, a range corresponding to the predetermined distance (d1) may be expressed by coloring or the like in a terminal image. For example, a voice can reach a red area, but cannot reach a blue area.

Further, in the present embodiment, the first dialog processing unit 1601 may restrict a dialog between general users who do not have a predetermined relationship more than a dialog between general users who have a predetermined relationship. The restriction of a dialog may be realized by restriction on time, frequency, or the like of a dialog. Further, the restriction of a dialog is a concept including prohibition of a dialog.

The predetermined relationship is arbitrary, but may be a relationship that forms a group, or may be a relationship between a parent and a child or between close relatives, or a relationship between users of similar ages. Or, the predetermined relationship may be a relationship of having a predetermined item (for example, a key, or the like). Further, an object such as an arrow indicating a direction of a next room may be displayed together with a sound effect or a sign board. Further, it is also possible to add effects such as increasing a restricted region where reverse travel (for example, moving back to a previous room) cannot be forcibly performed, collapsing a ground surface of an immovable area, and darkening.

In the present embodiment, the predetermined relationship may be determined based on data in the space state storage unit 146. In this case, the predetermined relationship may be a relationship of having similar user state information. For example, the first dialog processing unit 1601 may enable a dialog between general users related to user avatars (m1) located in space portions (rooms) related to the same content provision location. As a result, for example, in a case of multiple general users visiting in a virtual space in a group, when someone moves to a next room, a dialog within the group becomes impossible, and thus, such a change can also be enjoyed. Or, it also can be a motivation for catching up with a friend who has moved to the next room. Further, as a result, user behavior can be controlled by a natural guidance, and thus, there is an effect that the number of staff users performing user guidance can be reduced. Further, in order to indicate that a remaining user is the only remaining user, the number of persons in each room may be displayed on a screen, or a message such as “everyone is waiting in the next room” may be displayed.

The second dialog processing unit 1602 enables a dialog between a general user and a staff user via the network 3 based on an input from the general user and an input from the staff user. The dialog may be realized in a text and/or voice chat format via the corresponding user avatar (m1) and staff avatar (m2).

Further, as described above, the second dialog processing unit 1602 may function in cooperation with the assistance information provision unit 1544 of the staff avatar processing unit 154 or in place of the assistance information provision unit 1544. As a result, a general user can receive assistance in real-time from a staff user.

Further, the second dialog processing unit 1602 may enable a dialog between staff users via the network 3 based on inputs from multiple staff users. The dialog between staff users may be in a private form, for example, open only between staff users. Or, the second dialog processing unit 1602 may change a range of staff users who can have a dialog with each other based on the information about the authority granted to each staff user. For example, the second dialog processing unit 1602 may grant a staff avatar (m2) related to a staff user having the supervisory authority the authority to talk to all staff users, and may grant a staff avatar (m2) related to a staff user having the operation authority the authority to talk to a staff user having the supervisory authority only in certain cases.

In the present embodiment, the second dialog processing unit 1602 determines, among multiple general users, a general user who can talk to a staff user based on the locations of the user avatars (m1) and the location of the staff avatar (m2). For example, similar to the first dialog processing unit 1601 described above, when a distance between one staff avatar (m2) and one user avatar (m1) is equal to or less than a predetermined distance (d2), a dialog between the staff user related to the one staff avatar (m2) and the general user related to the one user avatar (m1) may be enabled. The predetermined distance (d2) may be appropriately set according to a size of a virtual space or each room, or the like, and may be fixed or variable. Further, the predetermined distance (d2) may be longer than the predetermined distance (d1).

Further, the second dialog processing unit 1602 may change a dialog ability based on the information about the authority granted to a staff user. For example, the second dialog processing unit 1602 may apply a largest predetermined distance (d2) to a staff avatar (m2) related to a staff user having the supervisory authority, and apply a next largest predetermined distance (d2) to a staff avatar (m2) related to a staff user having the operation authority. Further, the second dialog processing unit 1602 may grant a staff avatar (m2) related to a staff user having the supervisory authority a function (a function like a voice of heaven) to talk to all users. Or, the second dialog processing unit 1602 may allow a staff avatar (m2) related to a staff user having the supervisory authority to perform any dialog, but may allow staff avatars (m2) related to staff users having the other authorities to perform dialogs only related to their respective roles.

Further, in the present embodiment, based on a request (input) from a staff user, the second dialog processing unit 1602 may change general users who can talk to the staff user. For example, the second dialog processing unit 1602 may increase a range of general users who can talk to a staff user by temporarily increasing the predetermined distance (d2) described above. As a result, for example, when a staff user finds a user avatar (m1) who is likely to need assistance at a relatively distant location from the staff avatar (m2) of the staff user, the staff user can relatively quickly talk to the general user of the user avatar (m1). In this case, the staff action processing unit 1542 may instantly move the staff avatar (m2) of the staff user to a vicinity of the user avatar (m1) who is relatively far away (that is, a movement contrary to the predetermined law described above may be realized). As a result, the general user whom the staff user is talking to can immediately recognize the talking staff avatar (m2) via the terminal image displayed on the terminal device 20 of the general user, and thus, can gain an enhanced sense of security and receive assistance through a smooth dialog.

The activity restriction unit 162 restricts activities of user avatars (m1) in a virtual space related to multiple contents provided by the content processing unit 159. Activities related to contents may be the reception of the provision of the contents itself, and may further include actions and the like (such as movements) for receiving the provision of the contents.

In the present embodiment, the activity restriction unit 162 restricts the activities based on the data in the space state storage unit 146.

Specifically, the activity restriction unit 162 restricts activities of user avatars (m1) in a virtual space based on the success or failure information (see FIG. 9) of the next room movement condition. For example, the activity restriction unit 162 prohibits a general user who does not satisfy a content provision condition of one content from moving to a content provision location of the one content. Such movement prohibition may be realized in any mode. For example, the activity restriction unit 162 may disable an entrance to the content provision location of the one content only for a general user who does not satisfy the content provision condition of the one content. Such disabling may be realized by making the entrance invisible or difficult to see, or by setting a wall of the entrance that the user avatar (m1) cannot pass through.

On the other hand, the activity restriction unit 162 permits a general user who satisfies a content provision condition of one content to move to a content provision location of the one content. Such movement permission may be realized in any mode. For example, the activity restriction unit 162 may enable an entrance to the content provision location of the one content only for a general user who satisfies the content provision condition of the one content. Such enabling (transition from the disabled state) may be realized by changing the entrance from the invisible state to a visible state, or by removing the wall of the entrance that the user avatar (m1) cannot pass through. Further, such movement permission may be realized based on an input by a staff user. In this case, a staff user may detect a user avatar (m1) satisfying a next room movement condition based information that is normally invisible (for example, success or failure information of the next room movement condition). Further, not only for such a spatial movement or visibility, division by the first dialog processing unit 1601, such as a state in which an allowed general user is unable to talk to (for example, to perform a voice conversation with) a general user who is not yet allowed, may also be realized. As a result, for example, leak of an unnecessary hint from a preceding general user to a subsequent user, or a spoiler, or the like can be prevented. Further, since a subsequent general user cannot proceed to a next step unless he/she solves a problem by himself/herself, it is possible to encourage such a general user to independently participate (solve).

Based on an input from a staff user, the condition processing unit 164 relaxes content provision conditions of some or all of multiple specific contents that can be provided by the content processing unit 159 for some general users among multiple general users. Or, based on an input from a staff user, the condition processing unit 164 may tighten content provision conditions of some or all of multiple specific contents that can be provided by the content processing unit 159 for some general users among multiple general users. That is, based on an input from a staff user, the condition processing unit 164 may change a content provision condition to be applied to a specific one of general user between a normal condition and a relaxed condition (see FIG. 8). As a result, since the strictness of a content provision condition can be changed according to a staff user's discretion or the like, an appropriate content provision condition can be set according to an applicability or level of each general user.

In the present embodiment, the condition processing unit 164 may change a content provision condition based on inputs from all the staff users. However, the condition processing unit 164 may change a content provision condition based on an input from a staff user who satisfies a predetermined condition. For example, the condition processing unit 164 may change a content provision condition based on an input from a staff user having the supervisory authority. As a result, since only a staff user having the supervisory authority can set an appropriate content provision condition, a fair balance among general users can be achieved.

Based on the user state information 900 (see FIG. 9) associated with each of the general users, the extraction processing unit 166 extracts a first user who has received provision of a predetermined number or more of contents, or who has received provision of a specific content, among multiple specific contents that can be provided by the content processing unit 159. The predetermined number is any number of 1 or more. However, in a virtual space in which N specific contents can be provided, the predetermined number may be, for example, N/2, or N.

The role allocation unit 167 assigns at least a part of a role related to a staff avatar (m2) in a virtual space to a user avatar (m1) associated with a general user extracted by the extraction processing unit 166 based on an input from a staff user or without an input from a staff user. That is, this general user is converted into a general user who can become a staff user, the staff Yes-No information related to this general user is updated, and a staff ID is assigned. A role assigned to the general user by the role allocation unit 167 is arbitrary, and may be, for example, a relatively low-importance part of a role of a staff user having the supervisory authority. Further, for example, the role assigned to the general user by the role allocation unit 167 may be the same role as a staff user granted with the normal authority or may be a part thereof. Alternatively, the role assigned to the general user by the role allocation unit 167 may be the same role as a staff user granted with the operation authority or may be a part thereof.

In this case, the role allocation unit 167 may assign at least a part of a role related to a staff avatar (m2) in a virtual space based on an input from a staff user having the supervisory authority. As a result, a general user can be selected as a candidate at a responsibility of a staff user having the supervisory authority. Therefore, for example, a staff user having the supervisory authority can have a general user, who has relatively deep understanding of a role to be assigned, efficiently function as a staff user and appropriately fulfill the role.

Further, a staff user having the supervisory authority can search/invite a general user as a candidate from other than general users extracted by the extraction processing unit 166. For example, in a situation where a staff user who sells a certain commodity (for example, clothing that certain avatars can wear) is vacant, a staff user having the supervisory authority can search for a general user who purchase the commodity frequently or in large numbers (for example, search based on the purchase item information of the user information 600), and solicit whether or not to become a staff user who purchases the item. In this case, a general user who purchases this commodity frequently or in large numbers is likely to be familiar with the commodity, and can be expected to provide appropriate advice or the like as a staff user to a general user who intends to purchase the commodity.

The role allocation unit 167 may increase or decrease a role to be assigned to a user who has been converted from a general user to a staff user based on an input from a staff user having the supervisory authority. As a result, it is possible to appropriately adjust the burden of the role of the user converted from a general user to a staff user. In this way, various kinds of information such as that shown by the staff information 602 in FIG. 6 may be assigned to a general user who has been converted to a staff user as a staff user. In this case, a user who has been converted from a general user to a staff user may be associated with information about a role in place of or in addition to the authority information of the staff information 602. A granularity of the information about a role is arbitrary and may be adapted according to a granularity of the role. This also applies to a role (authority information) of a staff user.

In this way, in the present embodiment, a user can become a staff user from a general user, and this can motivate a user who wants to be a staff user to receive provision of a predetermined number or more of contents. A general user who has received provision of a predetermined number or more of content is highly likely to have an ability acquired from the contents to fulfill an assigned role, and can efficiently realize an improvement in skills through specific contents.

In the present embodiment, a user who can become a staff user may be able to select whether to enter as a general user or as a staff user when entering a virtual space.

The space information generation unit 168 generates the space state information stored in the space state storage unit 146 described above, and updates the data in the space state storage unit 146. For example, the space information generation unit 168 periodically or irregularly monitors success or failure of a next room movement condition for each entering user, and updates the success or failure information of the next room movement condition.

The parameter updating unit 170 updates the staff point described above. For example, the parameter updating unit 170 may update the staff point according to an operation status of each staff user based on the space state information illustrated in FIG. 9. For example, the parameter updating unit 170 may update the staff point in a mode in which more staff points are given as an operating time becomes longer. Further, the parameter updating unit 170 may update the staff point based on the number of times of assistance provided to general users by chat or the like (an utterance volume, the number of utterances, the number of attendances, the number of complaints handled, and the like). Further, in a case where commodities or services are sold in virtual reality, the parameter updating unit 170 may update the staff point based on a sales status (for example, a sales volume) of the commodities or services by a staff user. Or, the parameter updating unit 170 may update the staff point based on satisfaction information (for example, an evaluation value or the like included in questionnaire information) for a staff user that can be input by a general user. The staff point may be updated as appropriate, or may be collectively updated, for example, periodically based on log information.

The commodities or services sold by a staff user may be commodities or services that can be used in reality, or may be commodities or services that can be used in virtual reality. The commodities or services sold by a staff user may be related to a content provided at a content provision location, and may include, for example, an item that can enhance experience associated with the content. For example, when the content is related to the travel described above, the item may be a telescope or the like that can see far away, or may be food that can be provided to an animal or the like. Further, when the content is related to sports or a concert, the item may be cheering goods, a right to take a commemorative photo or talk with a player or an artist, or the like.

The staff management unit 180 manages staff users based on activities via staff avatars (m2) in a virtual space.

In the present embodiment, a staff user can also experience virtual reality as a general user. That is, a staff user can be a staff user or a general user, for example, depending on his/her choice. In other words, a staff user is a general user who can become a staff user. This also applies to a user who can become a staff user by the role allocation unit 167 described above. Unlike a general user who cannot become a staff user, a general user who can become a staff user can wear a uniform as a special item (second object (m3)).

The staff management unit 180 includes a first determination unit 1801, a first attribute changing unit 1802, an evaluation unit 1803, a second determination unit 1804, a second attribute changing unit 1805, and an incentive granting unit 1806.

The first determination unit 1801 determines whether or not a user has changed between a staff user and a general user. That is, the first determination unit 1801 determines whether or not an attribute of a user has changed. When an attribute of a user is changed by the first attribute changing unit 1802 or the second attribute changing unit 1805, which will be described later, the first determination unit 1801 determines that the attribute of the user has changed.

When the first determination unit 1801 has determined that a user has changed between a staff user and a general user, the first determination unit 1801 causes the terminal image generation unit 1581 to reflect the change. Specifically, when a user has changed between a staff user and a general user, the terminal image generation unit 1581 reflects the change in a drawing mode of an avatar related to the user in a terminal image (a terminal image for a general user and/or a terminal image for a staff user) in which the avatar related to the user is drawn. For example, when a user changes from a staff user to a general user, the terminal image generation unit 1581 draws an avatar corresponding to the user as a user avatar (m1). On the other hand, when a user changes from a general user to a staff user, the terminal image generation unit 1581 draws an avatar corresponding to the user as a staff avatar (m2) (that is, an avatar wearing a uniform).

Further, when the first determination unit 1801 has determined that a user has changed between a staff user and a general user, the first determination unit 1801 causes the parameter updating unit 170 to reflect the change in the staff point (see FIG. 6). For example, when a user has changed to a staff user, the parameter updating unit 170 may start counting working hours of the user, and after that, when the user has changed to a general user, the parameter updating unit 170 may end the counting of the working hours of the user. The update of the staff point may be realized in real time or afterward.

Based on an attribute change request (an example of a predetermined input), which is a user input from a user (a general user who can become a staff user), the first attribute changing unit 1802 changes the user between a staff user and a general user. That is, the first attribute change unit 1802 changes an attribute of a user based on an attribute change request from the user.

The attribute change request may be a direct request (for example, an input specifying a staff user or a general user) or an indirect request. In the case of an indirect request, the attribute change request may be, for example, a request in which a common visible feature is associated with the user avatar (m1) of the user, and may include a request for changing clothing from plain clothing to a uniform related to the avatar or a request for changing clothing from a uniform to plain clothing related to the avatar. In this case, the request for changing clothing from plain clothing to a uniform related to the avatar corresponds to an attribute change request from a general user to a staff user, and the request for changing clothing from a uniform to plain clothing related to the avatar corresponds to an attribute change request from a staff user to a general user. Further, for a staff user who can select a desired common visible feature from multiple kinds of common visible features, an attribute change request related to this staff user may include information indicating the kind of the common visible feature selected by the staff user from the multiple kinds of the common visible features.

An attribute change request by a user (a general user who can become a staff user) may be input at any timing. For example, a general user who can become a staff user may be able to change from a general user to a staff user or from a staff user to a general user, after entering a virtual space, for example, depending on a mood, a situation, or the like at that time. Or, an attribute change request by a user may be input under a predetermined condition. For example, an attribute change request for changing from a staff user to a general user may be input in a case where an assistance target user avatar (m1) does not exist in the virtual space, or in a case where the staff avatar (m2) related to the staff user is not in an activity (for example, talking to an assistance target user avatar (m1)). Further, an attribute change request for changing from a general user to a staff user may be input, for example, in a case where the user avatar (m1) related to the general user is located at a predetermined location (for example, the location (SP202) illustrated in FIG. 2D, the location near the user's own locker 84 illustrated in FIG. 2D, or the like).

When a user is a staff user, the evaluation unit 1803 evaluates whether or not the user has appropriately fulfilled a predetermined role as a staff user. The predetermined role is a role assigned to the user when the user is a staff user, and differs depending on the authority of the staff user as described above. In this case, the evaluation unit 1803 may determine a role of each staff user based on the authority information of the staff information 602 (see FIG. 6). Basically, when a staff user is not active (there is no change in location or sight direction or the like of the user avatar (m1), no utterance, or the like), the evaluation unit 1803 may assign a low evaluation result that does not meet a predetermined criterion to be described later.

For example, the evaluation unit 1803 may evaluate, for a staff user having the normal authority, whether or not a predetermined role has been appropriately fulfilled based on a state of providing the above-described predetermined information to general users. In this case, the evaluation unit 1803 may evaluate, for a staff user having the normal authority, whether or not a predetermined role has been appropriately fulfilled further based on an evaluation input from a staff user having the supervisory authority (an evaluation input for the staff user having the normal authority). Similarly, the evaluation unit 1803 may evaluate, for a staff user having the operation authority, whether or not a predetermined role has been appropriately fulfilled based on whether or not various kinds of operations for staging have been appropriately executed. In this case, the evaluation unit 1803 may evaluate, for a staff user having the operation authority, whether or not a predetermined role has been appropriately fulfilled further based on an evaluation input from a staff user having the supervisory authority (an evaluation input for the staff user having the operation authority). The evaluation unit 1803 does not have to evaluate a staff user having the supervisory authority. This is because staff users having the supervisory authority are those who evaluate other staff users.

Or, the evaluation unit 1803 may evaluate whether or not a user has appropriately fulfilled a predetermined role as a staff user based on the staff point updated by the parameter updating unit 170 (see FIG. 6). In this case, the evaluation unit 1803 may realize the evaluation of each staff user based on a value or an increase mode of the staff point updated by the parameter updating unit 170.

Further, the evaluation unit 1803 may realize the evaluation of a staff user based on a sight direction (for example, eye orientation) of the staff avatar (m2) when the staff user assists a general user. In this case, whether or not the staff avatar (m2) is facing and talking to a user avatar (m1) may be evaluated in addition to evaluation items such as whether or not a dialog content is appropriate. Further, instead of the sight direction, a face orientation, a distance (a distance between the staff avatar (m2) and the user avatar (m1) in the virtual space), a position (for example, a standing position with respect to the assistance target user avatar (m1)), and the like may be considered. Further, in a case of a staff avatar (m2) who is assigned a role such as applauding or commenting (a so-called mob (crowd), extra, crowd-pleaser, cheerleader, or the like) by participating in a specified event, frequency and content and the like of clapping and commenting may be taken into consideration.

Further, the evaluation unit 1803 may realize the evaluation of a staff user based on activity of a general user after the staff user has assisted the general user. In this case, for example, in a virtual space related to an exhibition hall, whether or not a general user has smoothly reached a desired target location (a store or the like) by receiving assistance from the staff user may be evaluated. Further, in a virtual space related to an employment placement, whether or not a general user has smoothly reached a desired target location (such as a booth of a desired company) by receiving assistance from the staff user may be evaluated.

Further, the evaluation unit 1803 may realize the evaluation of a staff user based on a behavior of the staff when the staff user assists a general user. In this case, for example, in a virtual space related to a restaurant, whether or not a staff avatar (m2) who plays a role of a proprietress has been able to entertain a customer user avatar (m1) in an appropriate manner may be evaluated.

Further, for example, when a working condition (for example, working hours) is stipulated by a contract or the like, the evaluation unit 1803 may realize the evaluation of a staff user based on whether or not the working condition is satisfied.

Further, the evaluation unit 1803 may evaluate each staff user using various index values such as KPI (Key Performance Indicator) or sales results.

The second determination unit 1804 determines whether or not an evaluation result by the evaluation unit 1803 satisfies a predetermined criterion. For example, when an evaluation result by the evaluation unit 1803 is output in 3 stages of “excellent,” “normal,” and “fail,” an evaluation result of “good” or “normal” may satisfy the predetermined criterion.

The second attribute changing unit 1805 forcibly (that is, regardless of the above-described attribute change request) changes a staff user who does satisfy the predetermined criterion as determined by the second determination unit 1804 to a general user. As a result, a staff user who is not appropriately fulfilling a predetermined role can be excluded and the usefulness of the user assistance function by staff users in a virtual space can be appropriately maintained. Further, it is possible to motivate a staff user to appropriately fulfill a predetermined role.

The incentive granting unit 1806 grants an incentive to each of staff users based on the value of the staff point updated by the parameter updating unit 170. The staff users to be granted by the incentive granting unit 1806 may be all staff users or all staff users other than staff users having the supervisory authority.

The incentive granted to a staff user may be any incentive, and may be an item or the like that can be used in the virtual space where the staff avatar (m2) of the staff user is arranged, or may be an item or the like that can be used in another virtual space different from the virtual space where the staff avatar (m2) of the staff user is arranged. Further, an incentive may be a change in a predetermined role corresponding to a promotion, a change from the normal authority to the operation authority, or the like. Further, an incentive may be a bonus separate from a salary to a staff user.

FIG. 5 illustrates together a function 500 realized by a terminal device 20 related to a general user and a function 502 realized by a terminal device 20 related to a staff user. FIG. 5 illustrates only the functions related to the user assistance function among various functions realized by the virtual reality application downloaded to the terminal devices 20. In the virtual reality application, a user application realizing the function 500 and a staff application realizing the function 502 may be separately installed, or the function 500 and the function 502 may be switched by a user operation in one application.

A terminal device 20 related to a general user includes an assistance request unit 250. The assistance request unit 250 transmits an assistance request to the server device 10 via the network 3 based on an input from the general user. The assistance request includes a terminal ID associated with the terminal device 20 or a user ID of the virtual reality application that the user has logged in, and thereby, an assistance target user avatar (m1) is identified in the server device 10 based on the assistance request.

In the present embodiment, since an assistance target user avatar (m1) is detected by the assistance target detection unit 157 of the server device 10 as described above, the assistance request unit 250 may be omitted as appropriate.

A terminal device 20 related to a staff user includes a support execution unit 262, a condition changing unit 263, and a role assigning unit 264. Some or all of functions of the function 502 realized by a terminal device 20 related to a staff user to be described below may be realized by the server device 10. Further, the support execution unit 262, the condition changing unit 263, and the role assigning unit 264 illustrated in FIG. 5 are merely examples, and some of them may be omitted.

Based on a predetermined input from a staff user, the support execution unit 262 transmits, to the server device 10 via the network 3, an assistance request for providing assistance information to a general user by the assistance information provision unit 1544. For example, in response to a predetermined input from a staff user, the support execution unit 262 transmits, to the server device 10, an assistance request for transmitting assistance information to a user avatar (m1) detected by the assistance target detection unit 157 of the server device 10. The user avatar (m1) to which the assistance information is to be transmitted may be determined by a staff user. For example, a staff user may identify an assistance target user avatar (m1) (a user avatar (m1)that is not detected by the assistance target detection unit 157) based on normally invisible information that can be drawn in a terminal image (for example, success or failure information of the next room movement condition) as described above. Further, the assistance request may include information indicating details of assistance information to be generated.

Based on an input from a staff user, the condition changing unit 263 transmits a request (condition change request) for instructing a condition change by the condition processing unit 164 as described above to the server device 10. For example, in response to an input for a condition change from a staff user, the condition changing unit 263 transmits a condition change request for a specific user avatar (m1) to the server device 10. The specific user avatar (m1) may be an assistance target user avatar (m1) detected by the assistance object detection unit 157 of the server device 10, or may be determined by the staff user himself/herself as in the case of the transmission target of the assistance information.

Based on an input from a staff user, the role assigning unit 264 transmits to the server device 10 a request (role assignment request) instructing a role assignment by the role allocation unit 167 as described above. For example, in response to a role assignment input from a staff user, the role assigning unit 264 transmits a role assignment request to the server device 10. The role assignment request may include information for identifying a user avatar (m1) to which a role is to be assigned, information indicating details of a role to be assigned, and the like.

(Operation Example Related to User Assistance Function)

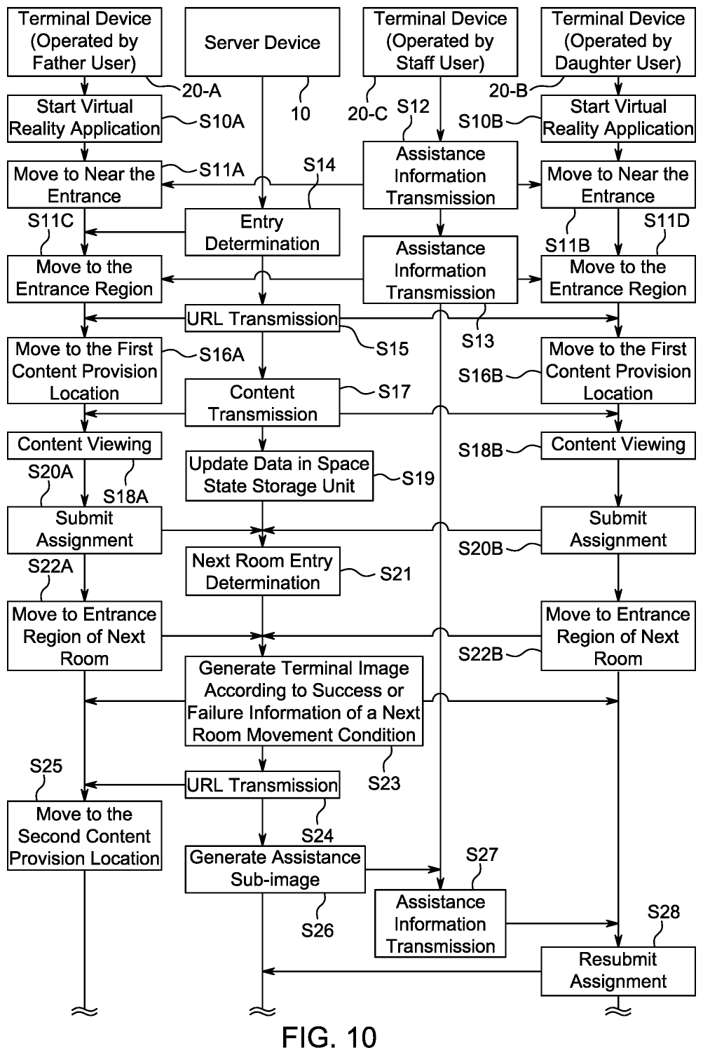

Next, with reference to FIGS. 10-18, an operation example related to the above-described user assistance function is described. Although the following operation example is a specific operation example, the operation related to the user assistance function described above can be realized in various modes as described above

In the following, as an example, an operation example related to the user assistance function described above is described with reference to the virtual space illustrated in FIG. 2B.

FIG. 10 is a timing chart illustrating an operation example related to the above-described user assistance function. In FIG. 10, for the sake of distinction, a terminal device 20 related to a general user is assigned a reference symbol “20-A,” a terminal device 20 related to another general user is assigned a reference symbol “20-B,” and a terminal device 20 related to a staff user is assigned a reference symbol “20-C.” In the following, for the sake of description, the general user related to the terminal device (20-A) is a user name “ami,” the general user related to the terminal device (20-B) is a user name “fuj,” and both are the students (for example, the user name “ami” is a student (A) and the user name “fuj” is a student (B)). Further, in the following, a general user related to the user name “ami” is referred to as a student user (A), and a general user related to the user name “fuj” is referred to as a student user (B). Further, in the following, multiple staff users will appear. However, the terminal device (20-C) is illustrated in a form encompassing the terminal devices 20 related to these staff users. Further, in FIG. 10, in order to prevent complication of the drawing, transmission of assistance information from the terminal device (20-C) to the terminal devices (20-A, 20-B) is illustrated in a direct mode, but may be realized via the server device 10.

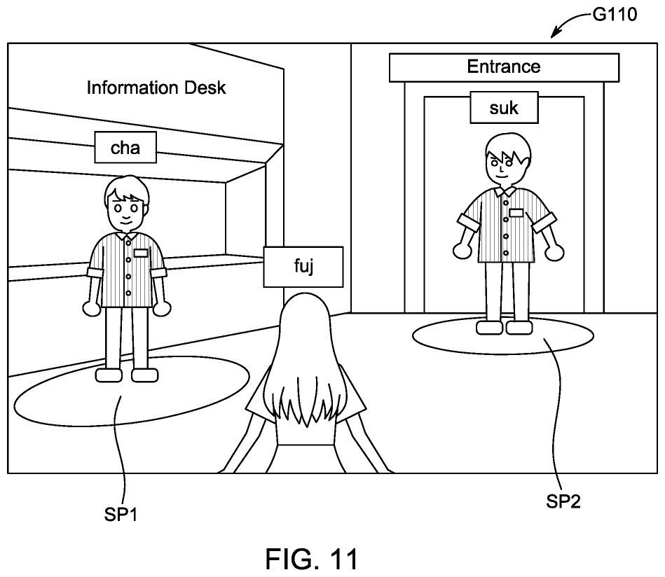

FIGS. 11, 12, and 14-18 are explanatory diagrams of the operation example illustrated in FIG. 10, and respectively illustrate examples of terminal screens in scenes. FIG. 13 schematically illustrates a state of the virtual space illustrated in FIG. 2B at a certain time.

First, in Step S10A, the student user (A) starts the virtual reality application in the terminal device (20-A), and in Step SlOB, the student user (B) starts the virtual reality application in the terminal device (20-B). The virtual reality application may be started with a time difference in each of the terminal devices (20-A, 20-B), and the start timing is arbitrary. Here, it is assumed that the staff user has already started the virtual reality application on the terminal device (20-C), but this start timing is also arbitrary.

Then, in Step 511A, the student user (A) enters the virtual space, moves his/her user avatar (m1), and reaches near the entrance related to the first content provision location. Similarly, in Step S11B, the student user (B) enters the virtual space, moves his/her user avatar (m1) in the virtual space, and reaches near the entrance related to the first content providing location. FIG. 11 illustrates a terminal image (G110) for the student user (B) when the user avatar (m1) of the student user (B) is located near the entrance related to the first content provision location. In the state illustrated in FIG. 11, it is assumed that the user avatar (m1) of the student user (A) is behind the user avatar (m1) of the student user (B). As illustrated in FIG. 11, it can be seen from the terminal image (G110) for the student user (B) that a staff avatar (m2) associated with a staff name “cha” is arranged in association with the location (SP1), and a staff avatar (m2) associated with a staff name “suk” is arranged in association with the location (SP2) corresponding to an entrance region related to the first content provision location.

In the present embodiment, as can be clearly seen from the terminal image (G110) illustrated in FIG. 11, since the staff avatars (m2) are wearing a uniform, general users such as the student user (A) and the student user (B) are less likely to mistake user avatars (m1) related to other general users for staff avatars (m2). As a result, each user can smoothly receive support (assistance) from a staff user in case of any trouble.

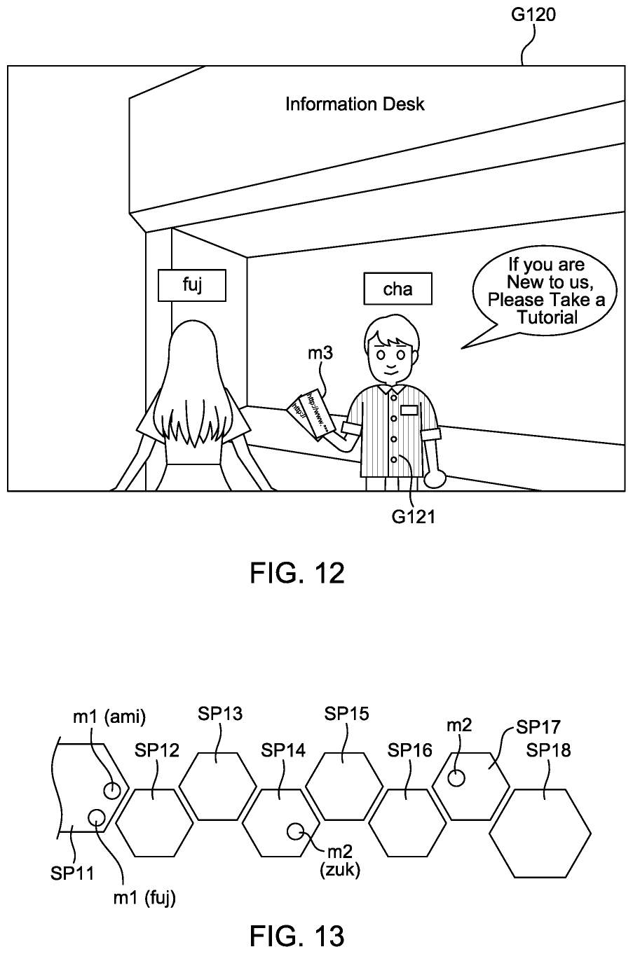

In this case, the student user (A) and the student user (B) may receive transmission of assistance information from the staff avatar (m2) having the staff name “cha” (Step S12). For example, the student user (A) and the student user (B) receive a content viewing guide for an entry tutorial. Such assistance information may include a URL for viewing the content of the entry tutorial. FIG. 12 illustrates a terminal image (G120) for the student user (B) when receiving assistance from the staff avatar (m2) of the staff name “cha” at the location (SP1). In FIG. 12, a chat text “If you are new to us, please take a tutorial!” based on an input of the staff user of the staff name “cha” is illustrated. Such a chat may be automatically generated.

When the student user (A) and the student user (B) watch the entry tutorial, they move to the location (SP2) corresponding to the entrance region (Step S11C, Step S11D). In this case, the student user (A) and the student user (B) may receive transmission of assistance information (Step S13) from the staff avatar (m2) of the staff name “suk” at the location (SP2). For example, the student user (A) and the student user (B) may receive assistance such as advice on a next room movement condition or the like. In this case, the server device 10 determines whether or not the next room movement condition of the student user (A) and the student user (B) is satisfied before Step S13 (Step S14). Here, it is assumed that the student user (A) and the student user (B) satisfy the next room movement conditions with the assistance of the staff user. In this case, the server device 10 transmits a URL for moving to the first content provision location to each of the terminal devices (20-A, 20-B) (Step S15). The URL for moving to the first content provision location may be drawn in a second object (m3) in a form of a ticket (see FIG. 12).

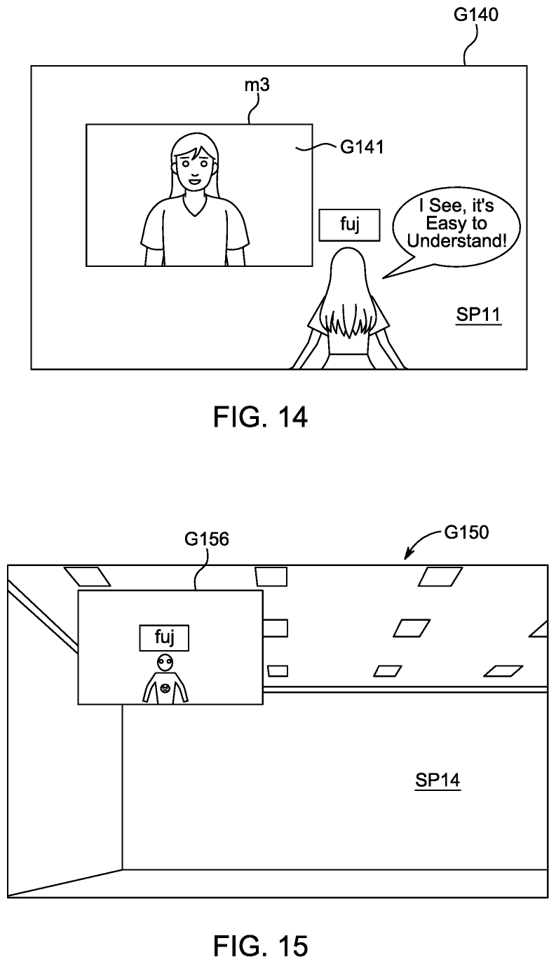

Then, the student user (A) and the student user (B) move to the first content provision location (see the first location (SP11) in FIG. 13) by accessing the URL transmitted from the server device 10 (Step S16A, S16B). In this way, when the student user (A) and the student user (B) move their respective user avatars (m1) to the first content provision location, the server device 10 transmits a specific content associated with the first content provision location to each of the terminal devices (20-A, 20-B) (Step S17). As a result, the student user (A) and the student user (B) can receive the provision of the specific content associated with the first content provision location (Step S18A, Step S18B). FIG. 14 illustrates a terminal image (G140) for the student user (B) when the provision of the specific content is received at the first location (SP11) of FIG. 13. The terminal image (G140) corresponds to a state in which a video content is output to an image unit (G141) corresponding to a large screen (a second object (m3)). The student user (A) and the student user (B) can view the video content on the large screen via their respective terminal images (G140), and thereby, the student user (A) and the student user (B) can receive the provision of the specific content at the first location (SP11). As illustrated in FIG. 14, the terminal image (G140) may include a chat text “I see, it's easy to understand!” based on an input from the student user (B). In this way, the student user (A) and the student user (B) can receive the provision of the specific content associated with the first content provision location while talking to each other as appropriate.

During this time, regularly or when a certain change occurs, the server device 10 updates the data (such as the room stay time in FIG. 9) in the space state storage unit 146 as appropriate based on a state of each of the user avatars (m1) of the student user (A) and the student user (B) (Step S19).

When the student user (A) and the student user (B) have finished receiving the provision of the specific content associated with the first content provision location, the student users (A) and the student users (B) submit an assignment and the like related to the specific content (Step 520A, 520B). A method for submitting the assignment and the like is arbitrary, and a URL for submitting the assignment may be used. Based on results of the submission of the assignment by the student user (A) and the student user (B) via their respective user avatars (m1), the server device 10 determines whether or not the next room movement condition of the student user (A) and the student user (B) is satisfied, and updates the data in the space state storage unit 146 (see the success or failure information of the next room movement condition in FIG. 9) (Step S21).

When the student user (A) and the student user (B) submit the assignment, they move their respective user avatars (m1) to an entrance region related to the second content provision location (Steps S22A, S22B) (see FIG. 13). The server device 10 generates a terminal image according to success or failure information of a next room movement condition based on success or failure information of the next room movement condition of each of the student user (A) and the student user (B) (Step S23). Here, it is assumed that the student user (A) satisfies the next room movement condition, but the student user (B) does not satisfy the next room movement condition. In this case, for example, the server device 10 generates a terminal image depicting an entrance that allows movement to the second content provision location for the student user (A), and generates a terminal image with a wall drawn at the entrance that allows movement to the second content provision location for the student user (B). Then, the server device 10 transmits a URL for moving to the second content provision location to the terminal device (20-A) (Step S24). The URL for moving to the second content provision location may be drawn on the terminal image in which the entrance that allows movement to the second content provision location is drawn. In this case, the terminal device (20-A) may detect the URL by image recognition or the like and automatically access it. As a result, the student user (A) can advance the user avatar (m1) to the second content provision location (Step S25).

On the other hand, in the terminal image for a staff user, the server device 10 draws the user avatar (m1) of the student user (B) as an assistance target user avatar (m1) in a mode different from the other user avatars (m1) (the above-described predetermined drawing mode) (Step S26). In this case, the drawing mode of the assistance target user avatar (m1) may be a drawing mode in which, as described above, when a staff user sees it, he or she can know the status (for example, “provision of a specific content has been received but a next room movement condition is not satisfied”).

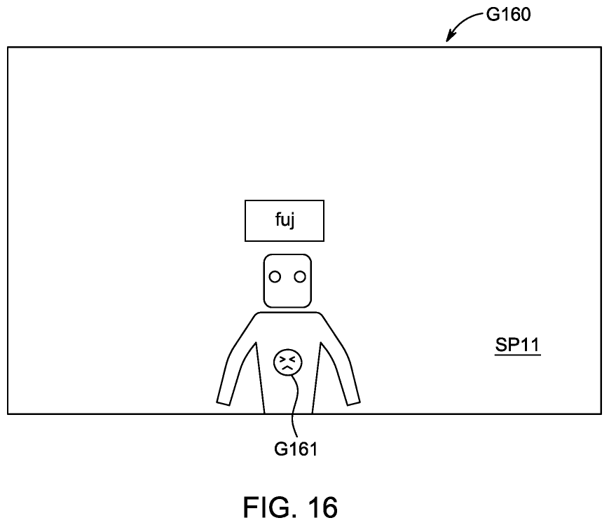

In the present embodiment, when an assistance target user avatar (m1) is detected, the server device 10 superimposes and displays an assistance sub-image on a main image in a terminal image for a staff user. FIG. 15 illustrates a terminal image (G150) for a staff user when an assistance target user avatar (m1) is detected. In the terminal image (G150) for a staff user, a sub-image (G156) appears when an assistance target user avatar (m1) is detected. In this case, the sub-image (G156) shows the assistance target user avatar (m1) (user name “fuj”). A staff user can instantly move the staff avatar (m2) to a location related to the sub image (G156) by tapping the sub image (G156), for example. In this case, the sub image (G156) is displayed in a full screen, and a terminal image (G160) as illustrated in FIG. 16 is displayed on the terminal device (20-C) of a staff user who is related to a staff avatar (m2) (staff name “zuk”) and has tapped the sub image (G156). In the terminal image (G160), the assistance target user avatar (m1) is associated with a characteristic image unit (G161) indicating that there is a high possibility that assistance by dialog is needed. Therefore, a staff user can easily identify the assistance target user avatar (m1) even when the terminal image (G160) includes multiple user avatars (m1). Here, it is assumed that a staff user (staff name “zuk”) related to a staff avatar (m2) located in a room related to a location (SP14) in FIG. 13 has instantly moved the staff avatar (m2) to the first location (SP11) by tapping the sub image (G156).

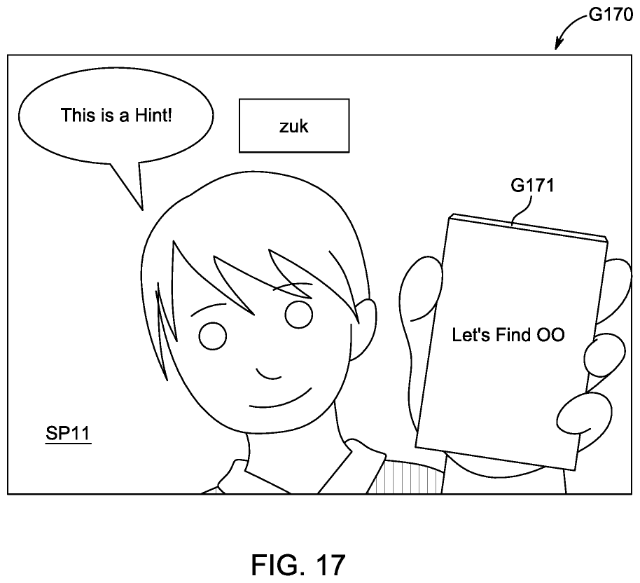

In this way, when a staff user finds the assistance target user avatar (m1) (user name “fuj”), the staff user can move his/her staff avatar (m2) to near the assistance target user avatar (m1) (user name “fuj”) and transmit assistance information through a dialog or the like. As described above, in the terminal image for a staff user, normally invisible information (for example, a reason why a next room movement condition is not satisfied) is drawn. Therefore, a staff user can understand the reason why the user avatar (m1) of the user name “fuj” does not satisfy the next room movement condition, and thus, can transmit appropriate assistance information according to the reason. Here, the staff user (staff name “zuk”) related to the staff avatar (m2) located in the room related to the location (SP14) in FIG. 13 instantly moves the staff avatar (m2) to the first location (SP11) and transmits assistance information to the general user with the user name “fuj” by dialog (Step S27). FIG. 17 illustrates a terminal image (G170) for the student user (B) when the assistance information is transmitted. As illustrated in FIG. 17, the terminal image (G170) may include an image unit (G171) showing a hint, and a chat text “This is a hint!” based on an input from the staff user related to the staff avatar (m2) (staff name “zuk”). As a result, the student user (B) can understand the reason why he/she could not move to the next room, and can resubmit assignment that satisfies the next room movement condition based on the hint (Step S28).

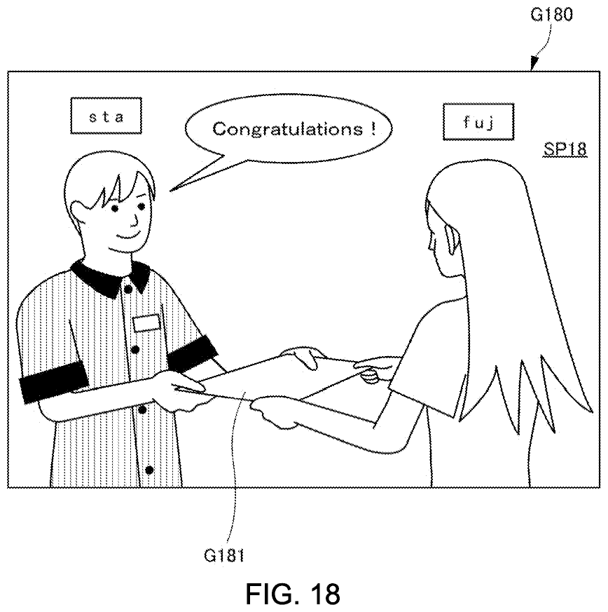

In this way, the student user (A) and the student user (B) receive provision of a corresponding specific content in each room (each content provision location), and proceed to a next room in order by clearing a corresponding assignment while receiving assistance from a staff user as appropriate. During this time, with assistance from staff users, it is possible to proceed smoothly, for example, to the eighth location (SP18) as a goal. FIG. 18 illustrates a terminal image (G180) for the student user (B) when successfully arriving at the eighth location (SP18) as the goal. As illustrated in FIG. 18, the terminal image (G180) may include a completion certificate image unit (G181) and a chat text “Congratulations!” based on an input from a staff user related to a staff avatar (m2) (staff name “sta”). Further, the completion certificate may include a grade of this time. A general user who has obtained such a completion certificate may be extracted by the extraction processing unit 166 described above as a candidate to be assigned a role that can function as a staff user in a corresponding content provision virtual space unit. Alternatively, a general user who has obtained such a completion certifcate may be automatically assigned a role that can function as a staff user in a corresponding content provision virtual space unit by the role allocation unit 167 described above.

In the present embodiment, as illustrated in the terminal image (G110) illustrated in FIG. 11, each staff avatar (m2) is associated with a display of a corresponding staff name (for example, “cha”). However, instead of this, all staff avatars (m2) may be associated with a display such as “staff” (common visible feature). In this case, the display of “staff” may be different depending on authority information, for example, “senior staff” In this case, each staff avatar (m2) may be associated with a display of a corresponding staff name (for example, “cha”) only in the terminal image for the staff user. That is, in a terminal image for a staff user, each staff avatar (m2) is associated with a display of a corresponding staff name (for example, “cha”), and in a terminal image for a general user, each staff avatar (m2) may be associated with a common visible feature “staff.” As a result, information about each staff avatar (m2) (for example, a staff name, and the like) can be recognized among staff users.

Further, in the present embodiment, a mechanism may be added to prevent appearance of a general user wearing clothing that closely resembles the common visible feature (a general user impersonating a staff user). Such a mechanism is suitable in a case of specifications that allow each general user to freely arrange (customize) the clothing of his/her user avatar (m1). For example, the server device 10 may periodically detect avatars wearing clothing with the common visible feature by image processing, and check whether or not the attribute of the user ID associated with each of the avatars is a staff user. As a result, a possibility that the user assistance function is impaired due to the appearance of a general user of spoofing can be effectively reduced. Further, as a method for preventing impersonating a staff user, a method in which a certificate of being an official staff (authorized staff user) or an accessory such as an armband is drawn in association with a staff avatar (m2), a method in which a display proving that the user is a staff user is drawn in a terminal image when another user selects the staff user (touch or click), or any combination of these may be adopted as appropriate.

(Operation Example Related to Staff Management Function)

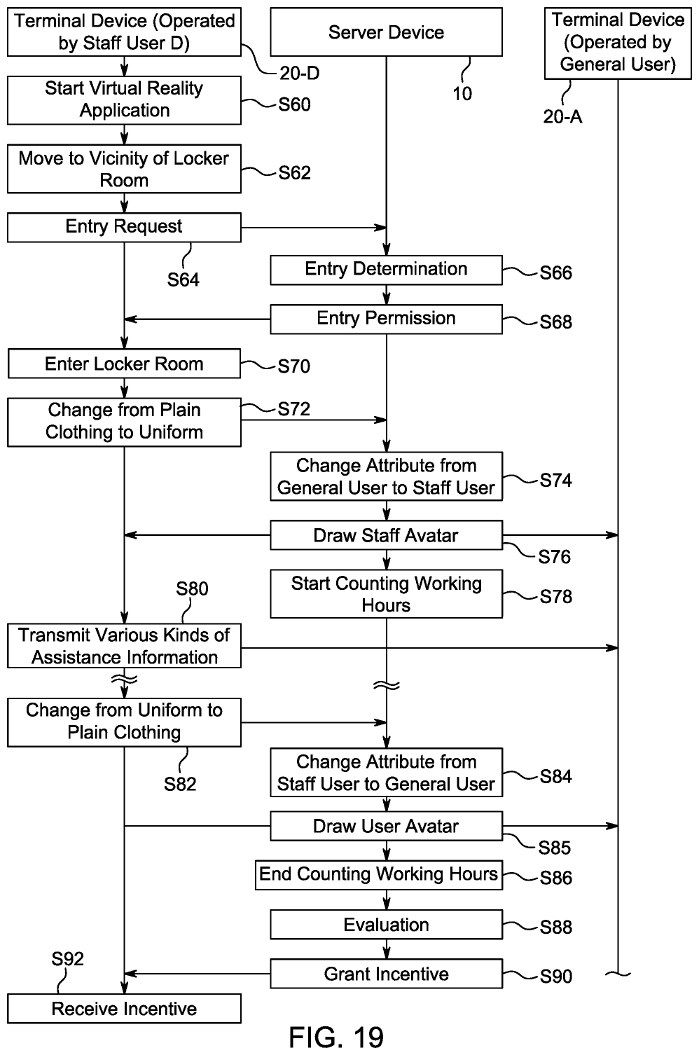

Next, with reference to FIG. 19, an operation example related to the staff management function described above is described. Although the following operation example is a specific operation example, the operation related to the staff management function described above can be realized in various modes as described above.

In the following, as an example, an operation example related to the user assistance function described above is described with reference to the virtual spaces illustrated in FIGS. 2B and 2D.

FIG. 19 is a timing chart illustrating an operation example related to the staff management function described above. In FIG. 19, for the sake of distinction, a reference symbol “20-A” is assigned to a terminal device 20 related to a general user, and a reference symbol “20-D” is assigned to a terminal device 20 related to a staff user (a general user who can become a staff user). In the following, for the sake of description, the user (general user who can become a staff user) related to the terminal device (20-D) is referred to as a user (D). Further, in FIG. 19, in order to prevent complication of the drawing, the transmission of assistance information from the terminal device (20-D) to the terminal device (20-A) is illustrated in a direct mode, but may be realized via the server device 10.

First, in Step S60, the user (D) starts the virtual reality application on the terminal device (20-D), and then, in Step S62, enters the virtual space, moves his/her user avatar (m1), and reaches a vicinity of the location (SP202) (see FIG. 2D) that forms a space unit corresponding to a locker room.

Then, in Step S64, the user (D) requests to move to the location (SP202) that forms the space unit corresponding to the locker room (enter the locker room). For example, the user (D) may request to move to the location (SP202) by holding a security card (second object (m3)) possessed by the avatar over a predetermined place.

Based on the user ID corresponding to the user (D) and the user information in the user database 140 (see the staff Yes-No information in FIG. 6), the server device 10 determines whether or not the user (D) is a general user who can become a staff user (Step S66). Here, since the user (D) is a general user who can become a staff user, the server device 10 notifies the user of entry permission (Step S68). For example, the server device 10 may notify the user of the entry permission by drawing the door 85 (second object (m3)), which restricts movement to the location (SP202) that forms the space unit corresponding to the locker room, in an open state in the terminal image for the user (D).

Then, in Step S70, the user (D) moves to the location (SP202) (enters the locker room) (Step S70), and changes his/her user avatar (m1) clothing from his/her plain clothing to a uniform in the locker room (Step S72). That is, the user (D) transmits an attribute change request for changing from a general user to a staff user to the server device 10. In response, the server device 10 changes the attribute of the user (D) from a general user to a staff user (Step S74). As a result, in a terminal image for a general user or a terminal image for a staff user (when the staff avatar (m2) related to this staff user is in the field of view), the avatar of the user (D) is drawn as a staff avatar (m2) wearing a uniform (Step S76). Further, the server device 10 starts a timer (working hour timer) that counts working hours of the user (D) in response to the attribute change (Step S78). The working hour timer may also be started based on an action from the user (D). For example, the user (D) may request the start of the working hour timer by holding a time card (second object (m3)) possessed by his/her avatar over a predetermined place.

As a staff user, the user (D) provides various kinds of assistance information to general users (Step S80). This is similar to Step S12, Step S13, and Step S27 in the operation example illustrated in FIG. 10, for example.

After that, the user (D) decides to finish the work in the virtual space and changes the clothing of his/her avatar from the uniform to plain clothing in the locker room (Step S82). That is, the user (D) transmits an attribute change request for changing from a staff user to a general user to the server device 10. In response, the server device 10 changes the attribute of the user (D) from a staff user to a general user (Step S84). As a result, in a terminal image for a general user or a terminal image for a staff user (when the staff avatar (m2) related to this staff user is in the field of view), the avatar of the user (D) is drawn as a user avatar (m1) not wearing a uniform (Step S85). Further, the server device 10 stops the timer (working hour timer) that counts the working hours of the user (D) in response to the attribute change and records the working hours (Step S86). The working hours may be reflected in the staff points (see FIG. 7) as described above. Further, a work start time and a work end time may be recorded in a table of the working staff information 902 (or the staff information 602).

Here, as an example, the user (D) is supposed to finish his/her work at his/her own intention (for example, with an operation such as pressing an exit button). However, as described above, the attribute may be forcibly changed to a general user by the second attribute changing unit 1805. In this case, retirement or dismissal may be realized. In either case, as described above, as soon as the attribute is changed to a general user, changing from the uniform to the plain clothing and deleting the plain clothing in the locker or closet (replacement with the uniform) may be realized at the same time. Further, in the case of retirement or dismissal, the staff ID may be deleted or invalidated, and various items related to the staff ID may be automatically deleted.

After that, the server device 10 evaluates the user (D) as a staff user (Step S88). The evaluation of a staff user is as described above in relation to the evaluation unit 1803. Then, the server device 10 grants an incentive to the user (D) (Step S90). In this case, the user (D) can be motivated to further improve his/her skill as a staff user by receiving the incentive (Step S92).

In the present embodiment, when the user (D) starts the virtual reality application, the user (D) may be able to select whether to enter a virtual space as a staff user or a general user. A general user who can become a staff user can enter a virtual space as a staff user. In this case, for example, when the user (D) chooses to enter a virtual space as a staff user, the avatar of the user (D) may be arranged near or at the location (SP202) that forms a space unit corresponding to a locker room (see FIG. 2D). Or, when the user (D) chooses to enter a virtual space as a staff user, the avatar of the user (D) may be arranged in a virtual space as a staff avatar (m2) wearing a uniform.

In the above, the embodiment has been described in detail with reference to the drawings. However, the specific structure is not limited to the embodiment, and designs and the like within a range that does not deviate from the gist of the present disclosure are also included.

For example, in the above-described embodiment, as an example, the staff information 602 (table) illustrated in FIG. 6 is exemplified. However, the present disclosure is not limited to this. For example, an ID of a user who manages/cares for appointment/employment of the staff may be set in a user table (or a user session management table in the room), such as an “employment manager ID.” In this case, a staff user to whom an employment manager ID is assigned can function as a supervisor who is notified when something goes wrong, and may be, for example, the following users:
Another user in the same room, a user who can be notified via a user management system when not actually online (that is, when it is not in operation).
A user who becomes a report destination when another user (for example, a guest user or a customer user) points out a problem of the staff user (it is also transmitted to humans along with a report system).
A user who can perform messaging or notification without the knowledge of other users when the staff asks for help.
Hierarchical structure: An employment manager also has an “employment manager ID” that manages it as his/her supervisor, and is a user who is in charge of staff care and support, KPI evaluation for missions, and educational guidance.
Virtualization: An intermediate manager does not have to be a real user, a user whose administrator receives notifications on his/her behalf when he/she is absent online or has no real user assigned.

In this case, when a staff user wants to make a report, for example, when a report-destination supervisor has already taken off his/her uniform and is not working (not in operation), it may be necessary to make a report to the supervisor. In this case, by using such information, a user management system can be realized as a mechanism for tracing to an ID of the supervisor. For example, information such as an organization table may be prepared as a separate item in a user table for a user management system. Such a user management system as a mechanism for tracing to a supervisor even when it is offline (not in operation) is very useful when the system is scaled.

### DESCRIPTION OF REFERENCE NUMERAL SYMBOLS

1: virtual reality generation system

3: network

10: server device

11: server communication unit (circuitry)

12: server storage unit (circuitry)

13: server control unit (circuitry)

20: terminal device

21: terminal communication unit (circuitry)

22: terminal storage unit (circuitry)

23: display unit (circuitry)

24: input unit (circuitry)

25: terminal control unit (circuitry)

140: user database

142: avatar database

144: content information storage unit (circuitry)

146: space state storage unit (circuitry)

150: space drawing processing unit (circuitry)

152: user avatar processing unit (circuitry)

1521: operation input acquisition unit (circuitry)

1522: user action processing unit (circuitry)

154: staff avatar processing unit (circuitry)

1541: operation input acquisition unit (circuitry)

1542: staff action processing unit (circuitry)

1544: assistance information provision unit (circuitry)

156: location/orientation information identification unit (circuitry)

157: assistance target detection unit (circuitry)

158: drawing processing unit (circuitry)

1581: terminal image generation unit (circuitry)

1582: user information acquisition unit (circuitry)

159: content processing unit (circuitry)

160: dialog processing unit (circuitry)

1601: first dialog processing unit (circuitry)

1602: second dialog processing unit (circuitry)

162: activity restriction unit (circuitry)

164: condition processing unit (circuitry)

166: extraction processing unit (circuitry)

167: role allocation unit (circuitry)

168: space information generation unit (circuitry)

170: parameter updating unit (circuitry)

180: staff management unit (circuitry)

1801: first determination unit (circuitry)

1802: first attribute changing unit (circuitry)

1803: evaluation unit (circuitry)

1804: second determination unit (circuitry)

1805: second attribute changing unit (circuitry)

1806: incentive granting unit (circuitry)

250: assistance request unit (circuitry)

262: support execution unit (circuitry)

263: condition changing unit (circuitry)

264: role assigning unit (circuitry)

1. An information processing system comprising:
space drawing processing circuitry configured to draw a virtual space; and
medium drawing processing circuitry configured to draw multiple mobile media that are moveable in the virtual space and are respectively associated with multiple users, wherein
the multiple mobile media include a first mobile medium associated with a user of a first attribute and a second mobile medium associated with a user of a second attribute to whom a predetermined role is assigned in the virtual space, and
the medium drawing processing circuitry is further configured to draw the second mobile medium in a display image for a user of the first attribute or for a user of the second attribute in a manner identifiable from the first mobile medium.

2. The information processing system according to claim 1, wherein the medium drawing processing circuitry is further configured to draw multiple second mobile media arranged in the virtual space in association with a common visible feature.

3. The information processing system according to claim 2, wherein a change to the common visible feature by each user of the second attribute is prohibited.

4. The information processing system according to claim 3, wherein the common visible feature includes clothing or an accessory.

5. The information processing system according to claim 1, wherein an attribute of one user can change between the first attribute and the second attribute.

6. The information processing system according to claim 5, further comprising:
first determination circuitry configured to determine whether or not an attribute of one user has changed between the first attribute and the second attribute, wherein
when the first determination circuitry determines that the attribute of the one user has changed between the first attribute and the second attribute, the medium drawing processing circuitry is further configured to change a drawing mode of a mobile medium associated with the one user in a display image for a user of the first attribute or for a user of the second attribute.

7. The information processing system according to claim 5, further comprising:
first attribute changing circuitry configured to change an attribute of one user between the first attribute and the second attribute based on an input from the one user.

8. The information processing system according to claim 7, wherein
the input includes a predetermined request for the medium drawing processing circuitry to draw the second mobile medium in a manner identifiable from the first mobile medium, and
the first attribute changing circuitry is further configured to change the attribute of the one user from the first attribute to the second attribute based on the predetermined request.

9. The information processing system according to claim 5, further comprising:
evaluation circuitry configured to evaluate whether or not the one user has played the predetermined role when the attribute of the one user is the second attribute;
second determination circuitry configured to determine whether or not an evaluation result by the evaluation circuitry meets a predetermined criterion; and
second attribute changing circuitry configured to change the attribute of the one user, for whom the second determination circuitry has determined that the predetermined criterion is not met, from the second attribute to the first attribute.

10. The information processing system according to claim 1, wherein the predetermined role is related to various kinds of assistance for users of the first attribute in the virtual space or operations for various performances in the virtual space.

11. The information processing system according to claim 10, wherein the various kinds of assistance include at least one of: various kinds of guidance for a user of the first attribute, guidance or sale of a commodity or service that can be used or provided in the virtual space, handling a complaint from a user of the first attribute, and various kinds of cautions or advice for a user of the first attribute.

12. The information processing system according to claim 11, further comprising:
user information acquisition circuitry configured to acquire predetermined user information that is useable in playing the predetermined role, wherein
the medium drawing processing circuitry is further configured to draw the first mobile medium in association with the predetermined user information in a display image for a user of the second attribute.

13. The information processing system according to claim 12, wherein the predetermined user information includes: a past usage or provision history or a guidance history, regarding commodities or services in the virtual space or other virtual spaces.

14. The information processing system according to claim 1, further comprising:
parameter updating circuitry configured to update a value of a parameter that is related to an amount of playing the predetermined role and is associated with each of the users of the second attribute.

15. The information processing system according to claim 14, wherein the amount of playing the predetermined role includes activity time in the virtual space via the second mobile medium.

16. The information processing system according to claim 15, wherein
the activity time in the virtual space via the second mobile medium includes working time, and
the parameter updating circuitry is further configured to start counting the working time of one user when the attribute of the one user changes to the second attribute and after that, ends the counting of the working time of the one user when the attribute of the one user changes to the first attribute.

17. The information processing system according to claim 14, further comprising:
incentive assigning circuitry configured to assign an incentive to each user of the second attribute based on the value of the parameter updated by the parameter updating circuitry.

18. An information processing method executed by a computer, comprising:
drawing a virtual space; and
drawing multiple mobile media that are moveable in the virtual space and are respectively associated with multiple users, wherein
the multiple mobile media include a first mobile medium associated with a user of a first attribute and a second mobile medium associated with a user of a second attribute to whom a predetermined role is assigned in the virtual space, and
in the drawing multiple mobile media, the second mobile medium in a display image for a user of the first attribute is drawn in a manner identifiable from the first mobile medium.

19. A non-transitory computer readable medium having stored therein a program that when executed by a computer causes the computer to implement an information processing method, comprising:
drawing a virtual space; and
drawing multiple mobile media that are moveable in the virtual space and are respectively associated with multiple users, wherein
the multiple mobile media include a first mobile medium associated with a user of a first attribute and a second mobile medium associated with a user of a second attribute to whom a predetermined role is assigned in the virtual space, and
in the drawing multiple mobile media, the second mobile medium in a display image for a user of the first attribute is drawn in a manner identifiable from the first mobile medium.
